(19) United States
(12) Patent Application Publication
(10) Pub. No.: US 2023/0019582 A1
(43) Pub. Date: Jan. 19, 2023

(54) METHOD, DEVICE, AND SYSTEM FOR MANAGING A MICRO MOBILITY DEVICE

(71) Applicants: HYUNDAI MOTOR COMPANY, Seoul (KR); KIA CORPORATION, Seoul (KR)

(72) Inventors: Jae Jun Ha, Hwaseong-si (KR); Young Jun Moon, Sejong-si (KR)

(73) Assignees: HYUNDAI MOTOR COMPANY, Seoul (KR); KIA CORPORATION, Seoul (KR)

(21) Appl. No.: 17/850,654

(22) Filed: Jun. 27, 2022

(30) Foreign Application Priority Data
Jul. 19, 2021 (KR) 10-2021-0093875

(51) Int. Cl. G06Q 50/30; G07C 5/00; B60L 53/68; B60S 5/00; B60W 60/00; G06Q 50/26

(52) U.S. Cl. CPC G06Q 50/30; G07C 5/008; B60L 53/68; B60S 5/00; B60W 60/0025; G06Q 50/26

(57) ABSTRACT

A method, device, and system for managing a micro mobility device are disclosed. The method includes obtaining access location information of a movable carrier for returning the micro mobility device and checking whether or not it is possible to return the micro mobility device to the movable carrier, based on use information of the micro mobility device and the access location information The method includes performing maintenance for the micro mobility device that is returned, when it is possible to return the micro mobility device to the movable carrier and it is confirmed, based on the use information and maintenance support information of the movable carrier, that maintenance of the micro mobility device is capable of being performed by the movable carrier.

### CROSS REFERENCE TO RELATED APPLICATION

The present application claims priority to Korean Patent Application 10-2021-0093875, filed Jul. 19, 2021, the entire contents of which are incorporated herein for all purposes by this reference.

### BACKGROUND

### Field of the Disclosure

The present disclosure relates to a method, device, and system for managing a micro mobility device. Particularly, the present disclosure relates to a method, device, and system for managing a micro mobility device, which realize efficient use of the micro mobility device by performing timely maintenance for the micro mobility device in a management system implemented by a computing device.

### Description of the Related Art

Along with technical advances, the notion of car ownership is being weakened or is waning, while the use of shared mobility devices is on the rise. Specifically, for the convenience of everyday life in a particular region or residence, the needs for shared mobility devices and related services are increasing. For the effortless, well ordered use of shared mobility devices in an area crowded with users, many shared mobility devices may be kept and managed near the crowded area.

In addition, a transportation demander, i.e., a person requesting use of a shared mobility device, may arrive at a destination not by walking but by mixing a means of public transportation and a shared mobility device. A regular route bus, a subway, an autonomous driving shuttle, a bus rapid transit (BRT), an urban air mobility (UAM), and the like may be provided as means of public transportation. In order to enhance connectivity with a public transportation service, a storage facility of shared mobility devices may be provided near a public transportation stop. A shared mobility device may be a more traditional vehicle, but according to the recent first & last mile trend, a micro mobility device may be utilized. For example, a micro mobility device may be a single-wheeled segway, a two-wheeled segway, an electric scooter, and an electric bicycle. The micro mobility device is a means of transportation that is more cost effective than larger, more traditional vehicles and is very suitable for short-distance travel. Accordingly, as the number of sharing services using micro mobility devices is increasing, the number of micro mobility devices to be managed is dramatically increasing. Unlike a shared vehicle that is returned to a designated space, the existing micro mobility device service may finish being used when a user parks the micro mobility device at any location. Furthermore, in case where a user abandons or discards a mobility device, which could be utilized through simple maintenance, in a site, the mobility device may run out of power so that a service platform may not ever retrieve the mobility device. In the service platform, this causes a burden on a system for operating micro mobility devices, and even simple maintenance is very difficult to carry out. An existing platform system simply manages the operation status and location of a micro mobility device but does not implement a process of managing the mobility device with respect to maintenance. As micro mobility devices may be normally utilized with only simple maintenance, the number of micro mobility devices that become inoperable is high due to the absence of a process for managing maintenance of the mobility devices. A platform system that is incapable of monitoring the status of abnormal mobility devices causes unnecessary resources to be used in an operating process of mobility devices.

### SUMMARY

A technical object of the present disclosure is to provide an improved method, device, and system for managing micro mobility devices, which realize efficient use of the micro mobility devices by performing timely maintenance on the micro mobility devices in a management system implemented by a computing device.

The technical objects of the present disclosure are not limited to the above-mentioned technical objects. Other technical objects that are not mentioned should be clearly understood by those of ordinary skill in the art through the following descriptions.

According to the present disclosure, a method for managing a micro mobility device through a computing device is provided. The method includes obtaining access location information of a movable carrier for returning the micro mobility device and checking whether or not it is possible to return the micro mobility device to the movable carrier, based on use information of the micro mobility device and the access location information. The method also includes performing maintenance on the micro mobility device that is returned, when it is possible to return the micro mobility device to the movable carrier and it is confirmed, based on the use information and maintenance support information of the movable carrier, that maintenance of the micro mobility device is capable of being performed by the movable carrier.

According to an embodiment of the present disclosure, in the method, the movable carrier may have an autonomous driving function.

According to an embodiment of the present disclosure, in the method, the movable carrier may be capable of autonomously driving within a management area that is set to a predetermined range from a multimodal station which is installed in a fixed location to store the micro mobility device.

According to an embodiment of the present disclosure, in the method, a multiplicity of multimodal stations having a management area may be installed. According to an embodiment of the present disclosure, in the method, when the micro mobility device is located outside a management area, the access location information may be set to a location closest to the micro mobility device within a permissible range in the management area. Also, the movable carrier is capable of moving to the closest location.

According to an embodiment of the present disclosure, in the method, the use information may have residual power information of the micro mobility device and mobility device location information. The checking of whether or not return to the movable carrier is possible may comprise determining whether or not the return is possible based on the power residual information, the mobility device location information, and the access location information.

According to an embodiment of the present disclosure, in the method, the maintenance support information may comprise charging support information according to power of the movable carrier. The method may further comprise controlling not to perform charging maintenance for the micro mobility device that is returned to the movable carrier, when it is confirmed that maintenance for charging the micro mobility device is impossible to perform.

According to an embodiment of the present disclosure, in the method, the movable carrier may be selected by being searched for based on at least one among location information of the micro mobility device, mobility device loading information of the movable carrier, and/or the maintenance support information.

According to an embodiment of the present disclosure, in the method, the use information may be recorded in at least one among: a user identification device, which is mounted on a user device and is capable of exchanging data with the micro mobility device; a mobility identification device mounted on the micro mobility device; and/or an authentication identification device applicable to the micro mobility device for user authentication. The recorded use information may be transmitted to at least one of the user device and a server.

According to an embodiment of the present disclosure, the method may further include transmitting, to a user device, a permission message for replacement with another mobility device loaded on the movable carrier, when the micro mobility device is returned to the movable carrier. The method may also include transmitting, to the user device, at least one of a non-permission message for replacement with another micro mobility device and/or a use prohibition message for a predetermined period, when the micro mobility device is not returned to the carrier.

According to an embodiment of the present disclosure, the method may further include: moving the movable carrier loaded with the micro mobility device to a multimodal station that is installed in a fixed location; determining whether or not there is a micro mobility device for which a charging request is made; moving the movable carrier to a charging zone of the multimodal station, when the charging request is made, and charging the micro mobility device for which the charging request is made; moving the movable carrier to a use waiting zone of the multimodal station after charging the micro mobility device; and moving the movable carrier to the use waiting zone of the multimodal station, when the charging request is not made.

According to an embodiment of the present disclosure, the method may further include determining a transfer point of the movable carrier that is located in the use waiting zone, based on a degree of demand for the micro mobility device. The method may also include controlling to move the movable carrier loaded with the micro mobility device to the transfer point.

According to an embodiment of the present disclosure, the method may further include determining whether or not use of the micro mobility device is restricted, based on the use information related to a usage state and operation of the micro mobility device, before the checking of whether or not it is possible to return the micro mobility device to the movable carrier. The checking of whether or not it is possible to return the micro mobility device to the movable carrier may be performed when the use is restricted.

According to an embodiment of the present disclosure, in the method, the use information may have residual power information of the micro mobility device and mobility device location information. The determining of whether or not the use is restricted may comprise determining use restriction of the micro mobility device when residual power is equal to or less than a first residual value. The checking of whether or not return to the movable carrier is possible may comprise determining whether or not the return is possible based on the power residual information, the mobility device location information, and the access location information.

According to an embodiment of the present disclosure, in the method, the use information may comprise usage state information, which has residual power information of the micro mobility device and mobility device location information, and operation information based on an operational state of the micro mobility device. The determining of whether or not the use is restricted may comprise determining whether or not a preset defect level is reached based on the operation information. The checking of whether or not the return to the movable carrier is possible may comprise determining whether or not the return is possible, based on the usage state information, the operation information, and the access location information.

According to an embodiment of the present disclosure, the method may further include: moving the movable carrier loaded with the micro mobility device to a multimodal station that is installed in a fixed location; determining whether or not there is a micro mobility device making a charging request, based on use restriction information of the micro mobility device of which use is restricted; moving the movable carrier to a charging zone of the multimodal station, when the charging request is made, and charging the micro mobility device making the charging request; determining whether or not there is a micro mobility device making a repair request, based on the use restriction information; and moving the movable carrier to a repair zone of the multimodal station, when the repair request is made, and requesting to repair the micro mobility device making the repair request.

According to an embodiment of the present disclosure, the method may further include moving the movable carrier to a use waiting zone of the multimodal station, in a case where the micro mobility device loaded on the movable carrier does not make the repair request, after the charging of the micro mobility device.

According to an embodiment of the present disclosure, the method may further include moving the movable carrier to a repair zone of the multimodal station, when the charging request is not made but the repair request is made. The method may also include moving the movable carrier to a use waiting zone of the multimodal station, when neither the charging request nor the repair request is made.

According to an embodiment of the present disclosure, the method may further include determining a transfer point of the movable carrier based on at least one of a degree of demand of the micro mobility device and a request from a micro mobility device, of which use is restricted, when maintenance of the micro mobility device is completed in the multimodal station. The method may also include controlling to move the movable carrier loaded with a normal micro mobility device to the transfer point.

According to another embodiment of the present disclosure, a computing device for managing a micro mobility device is provided. The computing device includes a transceiver configured to transmit and receive a signal and a processor configured to control the transceiver. The processor is further configured to: obtain access location information of a movable carrier for returning the micro mobility device; check whether or not it is possible to return the micro mobility device to the movable carrier, based on use information of the micro mobility device and the access location information; and control to perform maintenance for the micro mobility device that is returned, when it is possible to return the micro mobility device to the movable carrier and it is confirmed, based on the use information and maintenance support information of the movable carrier, that maintenance of the micro mobility device is capable of being performed by the movable carrier.

According to another embodiment of the present disclosure, a server implemented by a computing device and capable of executing a management process of a micro mobility device is provided. The server includes a transceiver configured to transmit and receive a signal and a processor configured to control the transceiver. The processor is further configured to: search for a movable carrier for returning the micro mobility device and obtain access location information of the movable carrier; check whether or not it is possible to return the micro mobility device to the movable carrier, based on use information associated with a state of the micro mobility device and the access location information; and control to perform maintenance for the micro mobility device that is returned, when it is possible to return the micro mobility device to the movable carrier and it is confirmed, based on the use information and maintenance support information of the movable carrier, that maintenance of the micro mobility device is capable of being performed by the movable carrier.

According to the present disclosure, a method, device, and system for managing a micro mobility device may be provided that realize efficient use of the micro mobility device by performing timely maintenance on the micro mobility device in a management system implemented by a computing device.

Effects obtained in the present disclosure are not limited to the above-mentioned effects. Other effects not mentioned above should be clearly understood by those of ordinary skill in the art from the following description.

### BRIEF DESCRIPTION OF THE DRAWINGS

FIG. 1 is a view illustrating that a micro mobility device and a user device communicate with another device via a network.

FIG. 2 is a view illustrating that a micro mobility device is shared based on a management system.

FIG. 3 is a view illustrating that a user device is managed based on a management system.

FIG. 4 is a view illustrating an example of management of a micro mobility device by means of a multimodal station.

FIG. 5 is a flowchart showing a method for managing a micro mobility device through a management system according to an embodiment of the present disclosure.

FIG. 6 is a flowchart showing a charging maintenance method through a movable carrier.

FIG. 7 is a view illustrating a movable carrier that charges a micro mobility device during autonomous driving.

FIG. 8 is a flowchart showing a managing process of repair maintenance using a movable carrier.

FIG. 9 is a flowchart showing a managing process when returning by a movable carrier.

FIG. 10 is a flowchart showing a maintenance method at a multimodal station.

FIG. 11A and FIG. 11B are views illustrating an example of maintenance at a multimodal station.

FIG. 12 is a flowchart showing a process of controlling a movable carrier after maintenance is completed.

FIG. 13 is a flowchart showing a method for managing a micro mobility device through a management system according to another embodiment of the present disclosure.

FIG. 14 is a view illustrating a device configuration according to an embodiment of the present disclosure.

### DETAILED DESCRIPTION

Hereinafter, embodiments of the present disclosure are described in detail with reference to the accompanying drawings so that those of ordinary skill in the art may easily implement the present disclosure. However, the present disclosure may be implemented in various different ways and is not limited to the embodiments described herein.

In describing embodiments of the present disclosure, well-known functions or constructions are not described in detail since they may unnecessarily obscure the understanding of the present disclosure. The same constituent elements in the drawings are denoted by the same reference numerals, and a repeated description of the same elements has been omitted.

In the present disclosure, when an element is simply referred to as being “connected to”, “coupled to” or “linked to” another element, this may mean that an element is “directly connected to”, “directly coupled to” or “directly linked to” another element or is connected to, coupled to, or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure. When a component, device, element, or the like of the present disclosure is described as having a purpose or performing an operation, function, or the like, the component, device, or element should be considered herein as being “configured to” meet that purpose or perform that operation or function.

The advantages and features of the present inventive concept and the ways of attaining them should become apparent with reference to embodiments described below in detail in conjunction with the accompanying drawings. Embodiments, however, may be embodied in many different forms and should not be construed as being limited to the example embodiments set forth herein. Rather, these embodiments are provided to make this disclosure complete and to fully convey the scope of the inventive concept to those of ordinary skill in the art.

Hereinafter, embodiments of the present disclosure are described with reference to the accompanying drawings.

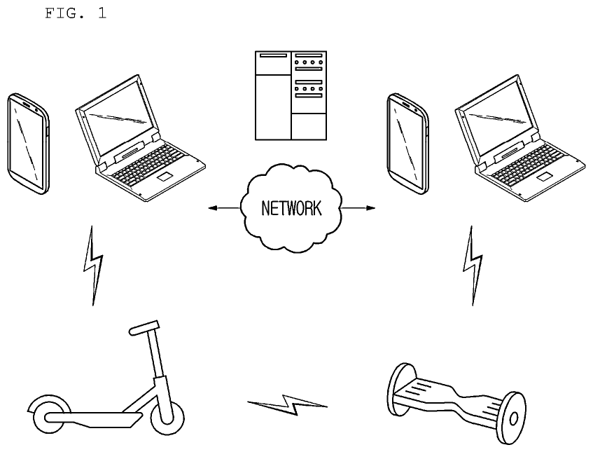

FIG. 1 is a view illustrating that a micro mobility device and a user device communicate with another device via a network.

Referring to FIG. 1, a micro mobility device may communicate with another mobility device or another device. Herein, as an example, the micro mobility device may communicate with another mobility device or another device based on cellular communication, WAVE communication, dedicated short range communication (DSRC), or other communication schemes. In other words, as a cellular communication network, a communication network such as LTE, 5G, WiFi communication network, WAVE communication network, etc. may be used. In addition, a local area network used in a micro mobility device, such as DSRC may be used. The present disclosure is not limited to the above-described embodiment.

In addition, as an example, regarding communication of a micro mobility device, for the security of the micro mobility device, a module capable of communicating with a user device and a module capable of communicating with an external server may be separated from each other. As an example, a micro mobility device may perform security-based communication like Bluetooth and NFC only with a device within a predetermined range from the micro mobility device. As an example, the micro mobility device and a personal device owned by a user may include a communication module for performing communication only with each other. In other words, the micro mobility device and the user's personal device may use a communication network disconnected from an external communication network. Also, as an example, the micro mobility device may include a communication module for performing communication with an external server. In addition, as an example, the above-described module may be implemented as a single module. In other words, based on a single module, a micro mobility device may communicate with another device, which is not limited to the above-described embodiment. In other words, in a micro mobility device, communication may be performed based on various methods and is not limited to the above-described embodiment.

Herein, for example, a micro mobility device may refer to a device capable of moving. As an example, “micro mobility device” may include a micro mobility device including at least three wheels for stable independent driving or a micro mobility device (e.g., a single-wheeled segway, a two-wheeled segway, an electric scooter, etc.) that has one or two wheels but is capable of being driven independently by keeping its balance. A micro mobility device may use electricity as a power source by means of a battery but is not limited thereto and may utilize any type of power sources capable of moving the mobility device. As an example, a micro mobility device may mean a means of transportation that may be taken or used by only one user. In addition, a micro mobility device may mean a means of transportation that a small number of users may use as a small means of transportation. As an example, not only a single-wheeled segway, a two-wheeled segway, and an electric scooter but also an electric wheelchair, an electric bicycle, and an electric two-wheeled vehicle may be a micro mobility device. In addition, a micro mobility device may be any other moving device and is not limited to the above-described embodiment.

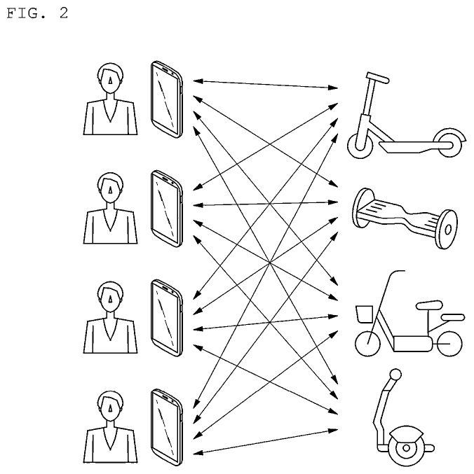

FIG. 2 is a view illustrating that a micro mobility device is shared based on a management system.

As an example, a management system may be applied to provide a sharing and maintenance service of a micro mobility device. A management system may be operated by data generation, processing, and exchange between computing devices. For example, a management system may be a system including at least one server, a multiplicity of user devices, and/or a multiplicity of micro mobility devices. For the service, a server may process a request of a user device, transmit a response message, and manage a micro mobility device by processing the reservation and allocation/return of the micro mobility device according to the request.

In addition, a server may perform overall management of use state and maintenance related to a micro mobility device by receiving use information including use state information and operation information from the micro mobility device or a user device. To this end, a management system may provide a multimodal station that is located in a predetermined region and is managed by a server 100 in order to perform maintenance. In addition, the management system may provide maintenance of a micro mobility device by being connected to a multimodal station and may operate a movable carrier that distributes micro mobility devices in a management area of the station according to a degree of demand. The movable carrier may be controlled by a server in charge of the management system.

Hereinafter, for convenience of explanation, a micro mobility device and a mobility device may be used together. Also, “mobility device” may be an abbreviation for a micro mobility device, if no particular restriction exists.

In addition, a management system may be a system including a multiplicity of devices and a multiplicity of micro mobility devices. In addition, as an example, the management system may further include a road side unit (RSU) and the like. Herein, a device may be a smart phone, a smart pad, and a smart watch. As another example, a device may be a device capable of performing other communication and exchanging a signal, which is not limited to the above-described embodiment. As another example, a RSU may be a roadside device capable of communication. In addition, as an example, a RSU may refer to a structure installed for transmitting and receiving a signal to and from a building or another area, which is not limited to the above-described embodiment. However, for convenience of explanation, such structures are referred to as RSUs in the description below. RSUs may be various structures or devices and are not limited to the above-described embodiments.

As another example, a management system may be a system where a micro mobility device is shared in a predetermined area. Herein, the predetermined area may be a regional concept like an apartment complex, a workplace, and a public transportation facility. As an example, the predetermined area may include an area in an apartment complex or an area a predetermined distance around the apartment complex. As another example, the predetermined area may mean an area a predetermined distance away from the workplace. As another example, the predetermined area may be a neighboring area of a public transportation facility in order to enhance connectivity with the facility. Mobility device status information of a management system may be provided to a platform of public transportation service so that users of public transportation can conveniently use mobility devices. As another example, an area to which a management system is applied may be a larger area like an administrative district or a city. The area to which a management system is applied is not limited to the above-described embodiments. In other words, the predetermined area may mean a reference range capable of operation based on a fleet system and may be changed by a user or a system.

In addition, as an example, a management system may be a system where a micro mobility device is shared by an authenticated user as a specific user (or device). As an example, a user may be a person, who has subscribed to a management system that may be provided in a predetermined service area and may share a micro mobility device that is parked at any place in a service area of the management system. A user may be a user outside a service area, and such a user may be a person who wants to use a sharing service by approaching a predetermined service area. As another example, a specific user may be a resident of an apartment in a predetermined range of area or a worker of an office located in a particular region, in which a service of a management system may be provided. As an example, a management system may provide a micro mobility device sharing service based on a device that an apartment inhabitant and/or an office worker has registered. Thus, a sharing service may be provided only to a specific person and the safety and management efficiency of a micro mobility device may be enhanced. However, a specific user using a shared moving object in a management system may be determined based on another method, which is not limited to the above-described embodiment. A shared mobility device may be provided in a management system. Herein, a shared mobility device may be a micro mobility device that has been authenticated and approved to be shared by the system. As an example, a shared mobility device may be a micro mobility device that is registered to a management system. Herein, a manager of the management system may provide a shared micro mobility device for the management system. In other words, only a micro mobility device authenticated or approved by a manager of a management system may be used as a shared micro mobility device. Thus, an accident that could occur due to the safety or management of a micro mobility device in a management system may be prevented. Specifically, a micro mobility device to be shared may be registered in a management system. The authority of registering a shared micro mobility device to a management system may be limited by the management system. Herein, a micro mobility device capable of being registered in the management system may have a same ID or same identification information. In addition, as a management system provides a shared micro mobility device, the management system may perform management of the shared micro mobility device. As an example, like residual power information of a micro mobility device registered to a management system, micro mobility device state information or micro mobility device operation information may be necessary information to provide a micro mobility sharing service for management of a shared micro mobility device. Herein, the management system may check the state of a shared micro mobility device in real time. For a micro mobility device having a problem, the permission for use may be restricted or a command of repair may be delivered through the system, based on which a service may be provided.

As another example, regarding the concrete operation of a management system, a service may be provided based on a device registered to the management system.

Specifically, the device registered to the management system may obtain information on a micro mobility device after authentication and security procedures with the system. In other words, from the perspective of the device, information on a shared micro mobility device may be provided. Herein, based on information on a shared micro mobility device, the device may be in contact with a micro mobility device to be used.

As an example, there may be a micro mobility device and a device (or user) that are registered to a management system. In other words, based on authentication and approval, only specific micro mobility devices and devices may be registered to a management system. Herein, the management system may be operated based on state information of the registered micro mobility devices and the registered devices. As an example, a management system may check information on a micro mobility device currently in use and location information of each micro mobility device in real time. Herein, as an example, each micro mobility device may transmit periodically its own information to a management system. In addition, as an example, each micro mobility device may transmit its own information to a management system based on an event trigger. As an example, when an event changing location or availability is triggered to a micro mobility device, the micro mobility device may transmit its own information to a management system (or server). In addition, the management system (or server) may check information on a registered device in real time. Herein, as an example, the registered device may not always use a service of the management system. Accordingly, activation information indicating whether or not the registered device uses the service of the management system may be needed. Herein, as an example, the management system may include list information for registered devices. Among the registered devices included in a list of the management system, a device that is currently using a micro mobility device or is activated to use a micro mobility device may be provided together with list information. For another example, a registered device (inactivated device) that does not use a management system, another registered device (activated device) that is using a micro mobility device of the management system, and yet another registered device (temporary device) that wants to use a micro mobility device may be separately indicated. In other words, information may be provided whether a device is actually using a micro mobility device, does not want to use any micro mobility device, or wants to use a micro mobility device but does not use one yet. In addition, as an example, for a device using a micro mobility device of a management system, usage state information may further be indicated. As an example, usage state information may further include information on expected time of use or information on location of use.

Specifically, a management system may include list information on a multiplicity of micro mobility devices and a multiplicity of devices that are registered. Herein, the list information may include at least one or more among use information of each micro mobility device, device location information, and status information of micro mobility devices and devices. Herein, the management system may provide a micro mobility device sharing service based on the device location information and location information included in the use information.

In addition, use information of a micro mobility device may include usage state information including location information and residual power information, which are generated while the micro mobility device is being used. The use information may also include operation information according to the operational state of the mobility device caused by a user's operation, may be transmitted to a server. The use information may be directly transmitted to the server by the micro mobility device or may be recorded in a user device and then be transmitted from the user device to the server.

Status information may be status data of all the micro mobility devices and all the devices and may include, for example, at least one or more among information on a mobility device in use, estimated time information of a mobility device in use, device/mobility device matching information, information on an inactivated device, information on an activated device, information on an inactivated mobility device, and information on an activated micro mobility device. In addition, status information may further include information on a mobility device that is being used by another device and estimated time information of a mobility device in use. In addition, status information may further include device/mobility device matching information based on information of a list type. In addition, status information may include activated device information and inactivated device information. As an example, as described above, activated device information may be a device that is using a mobility device or is ready to use a mobility device, among devices registered to a management system. As an example, the activated device may mean a device that executes a program or an application for the management system. Meanwhile, the inactivated device may be a device that is registered in the management system but does not use a shared mobility device. As an example, the inactivated device may be a device that does not execute or deactivates a program or application for the management system.

In addition, a management system may include information on an activated mobility device and information on an inactivated mobility device. Herein, as an example, the management system may include state information on a multiplicity of mobility devices. Herein, state information on a micro mobility device may be information on the micro mobility device regarding whether or not the mobility device has abnormality, remaining mileage, residual power and the like. In other words, state information on a micro mobility device may be information for determining whether or not the micro mobility device can be provided for sharing, which is not limited to the above-described embodiments. Herein, a management system may determine whether or not to activate the mobility device based on the above-described state information. As an example, for a mobility device that has no abnormality and is sufficiently charged, the management system may provide information indicating the mobility device as an activated micro mobility device. On the other hand, for a mobility device that has a problem in its condition, the management may classify the mobility device as an inactivated micro mobility device. Herein, the management system may provide information on the inactivated mobility device to an associated system or server. As an example, the associated system or server may perform repair or management for an inactivated mobility device, which is not limited to the above-described embodiments.

In addition, as an example, a management system may classify a micro mobility device with residual power below a predetermined level as an inactivated mobility device, as described above. As another example, when a mobility device with power below a predetermined level is shared through a device, a management system may provide information on power level to a user of the device through notification.

As an example, a device may be allocated a desired micro mobility device through a management system. Herein, as an example, a management system or server may allocate a micro mobility device to a device by using at least one of information on a mobility device in use, location information of a mobility device, location information of a device, and state information of a mobility device. Meanwhile, as an example, when a management system cannot allocate any micro mobility device, the management system may provide a device with information on the failure. In addition, as an example, a management system may allocate only a micro mobility device located a predetermined distance from the position of a device, which is not limited to the above-described embodiment. Next, the device may come within the predetermined distance from the micro mobility device. At this time, the device may transmit an authentication signal to the micro mobility device. In addition, as an example, a device may use a shared micro mobility device through a tag for the shared micro mobility device based on a list of available mobility devices. As an example, the device may tag a micro mobility device based on NFC, Bluetooth, or a magnetic means like a transportation card. Herein, when a shared moving object is tagged by the device, an authentication process is performed in a management system to allow the device to provide the micro mobility device. As an example, when authentication is completed based on device tag, operating power of a micro mobility device may be provided or lock may be released.

Concerning further detailed operation for authentication, when a device approaches a micro mobility device within a predetermined distance, an authentication signal may be transmitted to the micro mobility device. Herein, communication available to the micro mobility device and the device may be Bluetooth, NFC or tag, as described above. In other words, a procedure for authentication may be performed under certain conditions, which is not limited to the above-described embodiment. When a device approaches to or tags a corresponding micro mobility device, the device and the micro mobility device may exchange a signal so that it may be determined whether or not the device can use the micro mobility device and the device may be authenticated. Herein, the device may transmit, to the micro mobility device, an authentication signal including its identification information and identification information of a group in which the device is included. Herein, based on the identification information of the device included in the authentication signal thus received, the micro mobility device may confirm whether or not the device is registered to a management system. In addition, based on the identification information of the group included in the authentication signal, the micro mobility device may confirm whether or not the device is included in a group to which the micro mobility device may provide a service.

In other words, based on device identification information and group identification information, the micro mobility device may determine whether or not the device can use the micro mobility device. As an example, when the device cannot use the micro mobility device, the micro mobility device may transmit information on unavailability to the device. As an example, the device may obtain the information on unavailability from an application or another service providing program.

Meanwhile, when the device can use the micro mobility device, the micro mobility device may transmit a request signal for the execution of an authentication procedure to the device. In other words, in case the device is legally registered to the management system (or server) and the micro mobility device is capable of legally operating based on the management system, the micro mobility device may transmit a signal for requesting the execution of an authentication procedure to the device. Herein, the micro mobility device may include its own identification information and encryption key information in the signal for requesting the execution of an authentication procedure and transmit the signal to the device. As an example, both identification information of a micro mobility device and device information may be information registered in a management system. In this case, the micro mobility device may transmit a signal including the identification information of the micro mobility device, the identification information of the device, and the encryption key information to the management system.

In addition, the device may also transmit a signal including the identification information of the micro mobility device, the encryption key information and its own identification information, which are included in the request signal for the execution of an authentication procedure, to the management system.

Then, the management system may compare the information included in the signal received from the micro mobility device and the information included in the signal received from the device. Herein, when the identification information of the micro mobility device, the identification information of the device and the encryption key information are all consistent, the management system may recognize that the micro mobility device is available to the device. Next, the management system may transmit information confirming authentication to the micro mobility device and the device. Herein, the management system may register, to a database, information indicating that the device uses the micro mobility device. In addition, as an example, time for the device to use the micro mobility device and additional information may be continuously transmitted.

In addition, based on the information confirming authentication, the micro mobility device may register the device and open the door. In addition, the micro mobility device may be unlocked for use and let the device control the micro mobility device.

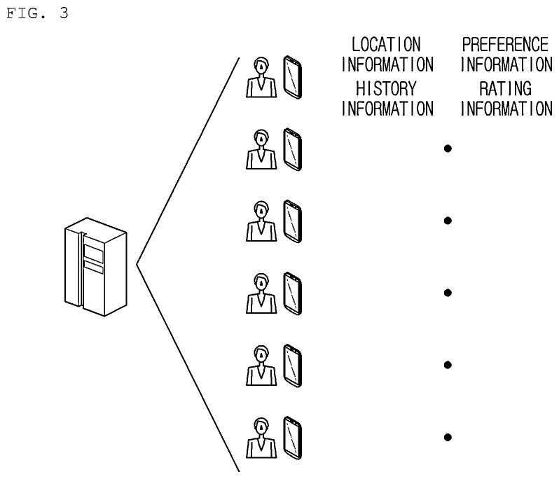

FIG. 3 is a view illustrating that a user device is managed based on a management system.

As an example, based on what is described above, a micro mobility device and a device may be managed in a management system. Herein, as an example, information of each user may be managed in the management system. As an example, information of each user may be information on the user's use based on user identification ID or the user's identification device. As a more concrete example, information of each user may include at least one or more among information on the user's location, information on the user's history, preference information, and rating information.

As an example, information on the user's location may be information for identifying the user's main route while using the management system. As an example, a user's location information may be static location information set by the user like the user's residence and place of work and dynamic location information like location information at time of use request and location information at expected time of use.

In addition, as an example, a management system may store history information of a user. History information may be information on a user's propensity, which is analyzed based on a type of a micro mobility device used by a user, a departure point, a travel route, a destination point, and a parking point during use. As an example, a management system may make a recommendation for the use of a micro mobility device based on a user's history information. In addition, as an example, a management system may perform management for allocating and distributing micro mobility devices by using history information of a multiplicity of users.

In addition, as an example, a management system may include information on a user's preference. As an example, information on a user's preference may be information that considers the frequency or preference of a micro mobility device which is used. Specifically, preference information may be a type of a micro mobility device that is designated by a user as a preferred one or is estimated as such. In addition, as an example, a user's preference information may be information input by the user, which is not limited to the above-described embodiment.

In addition, as an example, a management system may provide rating information of a user. Rating information may be rating levels given to each user based on use state information including subscription information for a management system and use performance information and after-use evaluation information. As an example, subscription information may be information on whether or not a long-term contract is made as a contract condition for a service of a management system and whether or not premium membership is signed up. Use performance information may include a frequency with which a user uses a moving object or mobility device, a fee according to time or distance, and the like. In case a user frequently uses a moving object or mobility device, the rating may be raised. Evaluation information may be generated based on exterior condition after use of a micro mobility device, occurrence of maintenance due to an accident and improper use, and a drastic increase in the degree of wear for mobility device components due to a user's poor use like sudden stop/speeding. Evaluation information may be produced or estimated by a subsequent user or a multimodal station after the return of a micro mobility device or from the above-described elements sensed by various sensors during/after use which are installed in the mobility device. A rating level may be raised when a micro mobility device is used without an accident or in a continuously good condition so that no unnecessary maintenance work is needed. Evaluation information may be written for each user based on a moving object or mobility device, which finishes being used, and use state information of the moving object or mobility device, which is generated from a server.

As an example, the above-described various information may be stored in a server controlling a management system and be managed. As another example, at least some of the above-described information may be installed in a micro mobility device or be stored in an identification device capable of tagging or in a user device capable of communicating in a system and a micro mobility device. When a micro mobility device is allocated and used by a user, an identification device may be utilized to identify and authenticate whether or not the user is a user making a reservation. An identification device may transmit data for controlling a micro mobility device, apart from for authentication, to the micro mobility device and a management system (server).

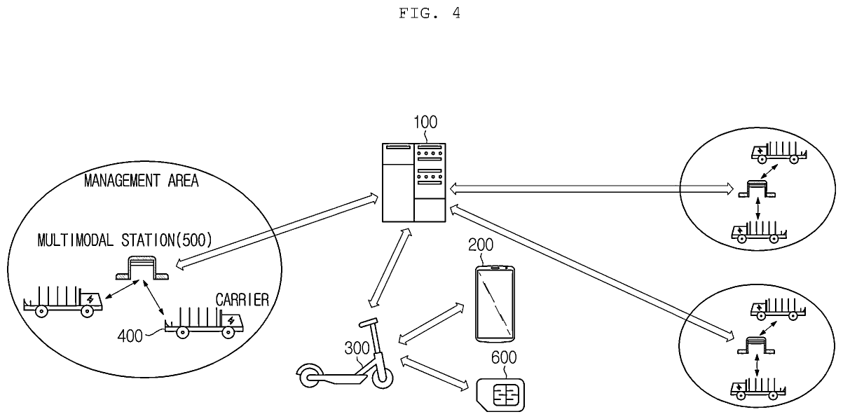

FIG. 4 is a view illustrating an example of management of a micro mobility device by means of a multimodal station.

A management system may run a multimodal station 500 that manages maintenance of a shared micro mobility device. The management system may include at least one management area in a service area, and at least one multimodal station 500 may be installed and operated in each management area. A management area may be set as a predetermined range from the multimodal station 500. As an example, a management area may be designated simply as a range of predetermined distance from the multimodal station 500. As another example, a management area may be determined depending on maintenance demand occurring in the multimodal station 500. Specifically, in case the number of micro mobility devices 300 requesting maintenance in a specific management area is normally larger than the one in another management area, the specific management area may be operated as a smaller range than the other management area. In addition, a management area with high demand for maintenance may have a multiplicity of multimodal stations 500, which may further expand the management area accordingly. As another example, a management area may be determined as a range of a distance where a movable carrier 400 is capable of moving from the multimodal station 500. Specifically, in case the movable carrier 400 drives autonomously, a management area may be set to a range of distance capable of communication with and control by the multimodal station 500. In addition, a management area may be expanded as there are many movable carriers 400 connected with the multimodal station 500. In addition to this, in case maintenance supported by the movable carrier 400 is performed by a maintenance worker, a management area may be set based on a range in which the maintenance worker can come around to maintain a multiplicity of carriers 400 within a suitable time. A management area is not designated as a fixed zone. The server 100 may control the management area according to the above-described situation so that the management area may be expanded or reduced.

The micro mobility device may be parked in a designated rental place or any place in a service area of a management system. A user may designate and use the micro mobility device 300, which is searched near a current location, by means of the user device 200. As an example, a rental place may be a facility that is installed in a fixed position for rent and return the micro mobility device 300. The multimodal station 500 may also be used as a designated rental place. As another example, a designated rental place may be a place where the movable carrier 400 stops at any time which is loaded with and carries the available micro mobility device 300 at the multimodal station 500.

The movable carrier 400 is a carrier that moves in manned or unmanned manner and may be configured to support a certain level of maintenance to the micro mobility device 300 that is put on the carrier. In case the movable carrier 400 is an unmanned carrier, the movable carrier 400 may drive autonomously in a management area through communication with the server 100, the multimodal station 500, and another movable carrier 400. A level of maintenance may be determined based on maintenance support information that is set to the movable carrier 400. As an example, maintenance support information may be charging support information according to power of the movable carrier 400. The movable carrier 400 may be equipped with a charging device in order to support charging maintenance for the micro mobility device 300. Charging support information may be generated by checking residual power of every micro mobility device 300 loaded on the movable carrier 400 and calculating a charging amount, which can be provided to the micro mobility device 300, and spare power of the carrier 400 based on the power of the movable carrier 400 and the checked residual power. For example, while the micro mobility device 300 is being charged which is already loaded, a charging demand requested by a newly loaded micro mobility device 300 may exceed the residual power of the carrier 400. In this case, the movable carrier 400 may notify charging support information regarding impossibility of charging support to the newly loaded mobility device 300 and may not support maintenance of the new mobility device 300. As another example, when charging support information is set to support charging for the newly loaded mobility device 300 in spite of insufficient residual power, the movable carrier 400 may support charging for the subsequently loaded mobility device 300 by adjusting a charging amount of the previously loaded mobility device 300 according to the charging support information.

As another example, maintenance support information may be information associated with component maintenance of the micro mobility device 300 which may be provided by the movable carrier 400. When the movable carrier 400 runs in a manned manner, component maintenance may be performed by repairing a corresponding component of the micro mobility device 300, for which maintenance is requested, by the hands of a driver of the carrier 400 or another maintenance worker. As another example, even when the movable carrier 400 drives autonomously in an unmanned manner, a maintenance worker may move to the carrier 400, which is requested from the server 100, through his device and support maintenance of the micro mobility device 300 for which maintenance is requested. For example, component maintenance may be repair of damage that occurs to the brake system, motor system, driving system, electric system, transmission system, lighting system, steering system, and exterior of the micro mobility device 300. Such repair may be the replacement of a component and maintenance.

The maintenance request may be a message that recognizes a damaged component by utilizing operation information based on data received from the micro mobility device 300 and requests repair of the damaged component. The operation information may be information that infers an operating condition and a degree of damage for each component based on data obtained from sensors mounted on the mobility device 300.

For example, sensor data may be location information, speed information, residual power information and vibration information, which are obtained from GPS, a speedometer, a power meter, and a vibration measuring sensor, which are mounted on the mobility device 300. In order to simplify a configuration of the mobility device 300 and to fabricate the mobility device 300 at low cost, sensor data may be transmitted to another device to be cumulatively stored therein, while the mobility device 300 is being used. For example, another device may be at least one among the user device 200 using the micro mobility device 300, the identification device 600 mounted on the micro mobility device 300, and an authentication and identification device that may be applied to the mobility device 300 for the purpose of user authentication.

As an example, in a case where sensor data is reported in the user device 200, the user device 200 may generate and produce operation record information based on the sensor data by using an operation record application installed in the device 200. Alternatively, the user device 200 may transmit recorded sensor data to the server 100 so that the server 100 may generate operation record information. For example, operation record information of the mobility device 300 may be driving routes, distance, power usage, sudden acceleration, sudden deceleration, the number of sudden turns, degree of vibration, the number of sudden brakes, braking situations, and the like. As another example, in a case where sensor data is recorded in the identification device 600 or an authentication and identification device, the devices may transmit the sensor data to the server 100, and the server 100 may generate operation record information.

The server 100 or the user device 200 may generate operation information according to an operational state of a component and its degree of damage by analyzing operation record information. For example, in the case of a brake system, operation record information including driving routes, sudden deceleration, the number of sudden turns, the number of sudden brakes, a degree of vibration, and braking situations may be generated based on sensor data. It is possible to produce, from the operation record information, a road surface condition in a driving route, a vibration level according to road surfaces, a slope driving distance, excessively sudden deceleration, the number of sudden brakes exceeding a certain deceleration range for a predetermined time, and the like. Through machine learning based on information thus produced, an operational state of a brake system and a degree of damage may be estimated, and corresponding operation information may be generated. Vibrations caused by poor road surface condition, driving a long distance on a downward slope, frequent sudden braking, and the like may cause operational states like brake pad wear, clearance between pad and lining, brake slips in a brake system, and even damage at a predetermined defect level and above in some cases. For example, in the case of a motor system, operation record information including driving routes, a distance, a degree of sudden acceleration, a degree of vibration, and power usage may be generated based on sensor data. It is possible to produce, from the operation record information, a road surface condition in a driving route, a vibration level, a driving distance, excessively sudden acceleration, power usage, and the like. Through machine learning based on information thus produced, an operational state of a motor system and a degree of damage may be estimated, and corresponding operation information may be generated. Vibrations caused by poor road surface condition, a long driving distance, sudden acceleration exceeding a certain range of speed, and power overuse may cause, in a motor system, operational states such as motor deterioration due to heat, abnormal wiring connections, poor motor rotation, abnormal delivery of power, poor mating of each component, and also damage at a predetermined defect level and above in some cases.

In addition, operation information may be generated not only from sensor data but also from texts, images, and videos which are related to abnormal operation and failure in a component of the mobility device 300 and are received the user device 200. The operation information may be an operational state and a degree of damage in each component, which are inferred from texts and images. When receiving a text about an abnormality of a component, the server 100 may request an image and a video for accurate checking to the user device 200. When receiving an image or a video, the server 100 may generate and record operation information by estimating through machine learning whether or not a component has an abnormality and failure and may transmit the operation information to the corresponding mobility device 300 and the user device 200.

Meanwhile, as described above, the multimodal station 500 may be used as a designated rental space for additionally renting and returning the micro mobility device 300. Depending on a degree of demand in a management area, the multimodal station 500 may designate a destination of the movable carrier 400 in order to distribute an available mobility device 300 to a suitable point or may control and move the movable carrier 400 to the destination.

Maintenance at the multimodal station 500 may include every maintenance supported by the movable carrier 400 and have an overall inspection and maintenance process that is not supported by the carrier 400. For example, the multimodal station 500 may be controlled to provide maintenance like replacement of a necessary component and repair according to charging and operation information of the micro mobility device 300.

At a request of the micro mobility device 300 and/or the server 100, when maintenance for the mobility device 300 is performed with reference to a maintenance message, the multimodal station 500 may generate and transmit maintenance information associated with a maintained part to the mobility device 300 and the server 100. In addition, based on the transmitted information, the server 100 may update the maintenance information of the mobility device 300.

As an example, a management system may be operated so that the central server 100 manages mobility state information related to the allocation/return state, location and use state of a moving object, and distribution and allocation of the movable carrier 400 according to a multiplicity of management areas and processes the above-described various information according to each user. As another example, a management system may be operated in a distributed way so that a slave system in charge of each management area is allocated to process and manage maintenance to the micro mobility device 300 and accepts a user's rental request in order to enable a master server at the center to manage a task and various information according to each user until the mobility device 300 is allocated. A master server may receive a processing result of maintenance and update maintenance information of the corresponding mobility device 300. Hereinafter, for the convenience of explanation, a central server is described to process a moving object and information of each user and to manage every management area. However, it is not excluded that such processing is performed in a master server and a slave system.

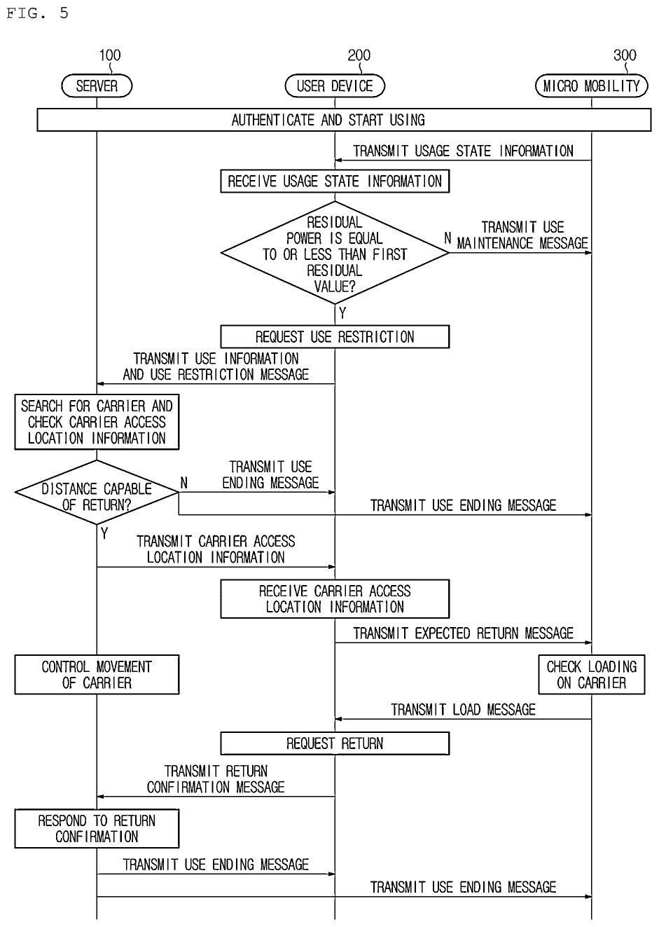

FIG. 5 is a flowchart showing a method for managing a micro mobility device through a management system according to an embodiment of the present disclosure.

At a user's rental request, the user device 200 may provide a location of the available micro mobility device 300 and request use of the micro mobility device 300 parked at a designated rental place or at an arbitrary place. For example, at a user's rental request, the user device 200 may receive, from the server 100, mobility status information including a type of the mobility device 300 parked near the user, location information, and residual power in a form of list. In this case, the user device 200 may select the mobility device 300 from the list and request to use the mobility device 300. At the request, the micro mobility device 300 may exchange use and mobility device identification information with the user device 200 through near field communication. The user device 200 may be allocated the micro mobility device 300 through authentication of identification information at the server 100 and start using the micro mobility device 300.

Since the start of use, the micro mobility device 300 may constantly transmit usage state information including location information, residual power information, speed information, and vibration information, which are obtained by sensors mounted on the micro mobility device 300, to the user device 200. In the present disclosure, for convenience of explanation, it is described that sensor data (or usage state information) are transmitted to and recorded in the user device 200 and the user device 200 analyzes charging and operational states of the mobility device based on the usage state information. However, as another example, usage state information may be cumulatively recorded in an identification device of the mobility device 300 or in an authentication and identification device applied to the mobility device 300. The state of the mobility device 300 may be analyzed as the identification device transmits sensor data to the server 100. As yet another example, usage state information may be transmitted to the server 100, not the user device 200 and an identification device, and the server 100 may analyze charging and operational states of the mobility device 300 based on the usage state information. In this case, the server 100 may transmit a message for restricting use of the micro mobility device 300 to the micro mobility device 300 and the user device 200 according to an analysis result.

Receiving usage state information from the micro mobility device 300, the user device 200 may determine, in the usage state information, whether or not residual power is equal to or below a first residual value. The first residual value may be a threshold value set by the server 100 and be information that the user device 200 receives from the server 100 after start of use. As another example, the server 100 may notify the first residual value to the micro mobility device 300 so that the first residual value may be already stored in the mobility device 300 and so that the residual value may be transmitted to the user device 200 after start of use. For example, the first residual value may be a residual amount of power required for the micro mobility device 300 to drive a certain distance at a predetermined output. For example, the certain distance may be a distance longer than an average distance for the mobility device 300 to reach at least one of the movable carrier 400 and/or the multimodal station 500 when being returned for charging. The average distance may be calculated by adding a predetermined distance to a reachable distance of the micro mobility device 300 that is calculated by considering a location of the multimodal station 500 and main stopping points of the movable carriers 400. As another example, the certain distance may be a statistical value, which is already collected, and may be set as a distance longer than a reachable distance in an average minimum time of use. In this case, the certain distance may be calculated by adding a predetermined distance to the reachable distance. The first residual value may be set equally according to a type of the micro mobility device 300 or be set differently, without such limitation, according to type, age, maintenance state caused by replacement of battery, and the like.

When residual power exceeds the first residual value, the user device 200 may transmit a use maintenance message to the micro mobility device 300 so that the mobility device 300 may continue to be used.

When residual power is equal to or below the first residual value, the user device 200 may provide a user with a message notifying beforehand that the use of the micro mobility device 300 will be restricted and may transmit use information including usage state information and a message requesting the use restriction to the server 100.

The server 100 may confirm identification information of the micro mobility device 300, for which use restriction is requested, record the identification information in mobility status information, and select the carrier 400 suitable for a state of the micro mobility device 300 by searching for the movable carrier 400 that is returnable. The server 100 may check access location information of the selected carrier 400.

For a specific description of the process, the server 100 may identify a management area, to which a location of the micro mobility device 300 belongs, based on current location information of the micro mobility device 300 that is extracted from usage state information.

From movable carriers 400 belonging to the identified management area, the server 100 may receive at least one of the mobility loading information, access location information and maintenance support information of the movable carriers 400. Mobility loading information may be information associated with the number of micro mobility devices 300 that occupy a carrier deck installed on the movable carrier 400. Access location information may be a location in a management area, where the movable carrier 400 stops. As another example, when the movable carrier 400 moves within a management area, access location information may be a destination point. Maintenance support information associated with charging support may include charging support information according to power of the movable carrier 400. Charging support information may be generated by checking residual power of every micro mobility device 300 loaded on the movable carrier 400 and calculating a charging amount, which can be provided to each micro mobility device 300, and spare power of the carrier 400 based on the power of the movable carrier 400 and the checked residual power. As charging amount/power in charging support information changes in real time, the movable carrier 400 may transmit maintenance information as charging support information at a request of the server 100.

Based on the information of the movable carriers 400 listed above, the server 100 may select preferably a carrier 400 capable of returning the micro mobility device 300. Based on the charging support information and access location information of the movable carrier 400, which is preferably selected, residual power information of the micro mobility device 300 and mobility location information, the server 100 may finally determine whether or not the carrier 400 is located within a distance capable of return. As for the determination process, in case the micro mobility device 300 has residual power incapable of reaching any one of the carriers 400 that are preferably selected, the server 100 may determine that it is impossible to provide a movable carrier 400 capable of return. Even when the micro mobility device 300 is located within a management area, the movable carrier 400 may stop farther than a certain distance expected by a first residual value. Also, residual power may be far below the first residual value since a user moves at an excessive speed immediately before the user checks a use restriction message or the message is generated. In the situation described above, no movable carrier 400 capable of return may be selected.

In case the movable carrier 400 cannot be provided, the server 100 may transmit a use ending message to the micro mobility device 300 and the user device 200. A user may finally end the use by requesting return of the micro mobility device 300 at a current location to the server 100. As another example, besides transmitting the message, the server 100 may perform final return processing by controlling and deactivating the micro mobility device 300. In this case, the server 100 may request the multimodal station 500, which belongs to a nearest management area of the mobility device 300, to move a pickup unit or a supporting unit dedicated to charging to the mobility device 300. The unit may approach the mobility device 300 to pick it up or to provide a charging service.

When the movable carrier 400 exists within a distance where the micro mobility device 300 can be returned, the server 100 may finally determine the carrier 400 as a return carrier. The server 100 may transmit access location information of the movable carrier 400, which is expected to return the micro mobility device 300, to the user device 200. Also, the server 100 may control and stop the movable carrier 400 in the transmitted access location until the micro mobility device 300 is returned. In case the movable carrier 400 is moving to a destination point as early as before a use restriction request, the server 100 may control and make the movable carrier 400 drive autonomously to the access location in unmanned manner or move in manned manner so that the mobility device 300 may be returned. In addition, the server 100 may transmit an expected return message to the micro mobility device 300 either directly or via the user device 200.

A user may drive the micro mobility device 300 to a corresponding movable carrier 400 by identifying access location information and put the micro mobility device 300 on the carrier 400. In response to a state where the micro mobility device 300 is normally loaded, the movable carrier 400 may transmit a load message to the user device 200. Receiving the load message, the user device 200 may transmit a return confirmation message to the server 100. In response to the message, the server 100 may transmit a use ending message to the user device 200 and the micro mobility device 300.

The above-described embodiment assumes that the micro mobility device 300, for which use restriction is requested, is located in a specific region of interest. As another example, in case of the micro mobility device 300 not located in any management area, the above-described embodiment may be applied similarly.

When confirming that the micro mobility device 300, for which use restriction is requested, is not located in any management area, the server 100 may select a nearest region of interest based on location information of the micro mobility device 300. Next, based on the information of the movable carriers 400 belonging to a selected region of interest, the server 100 may select preferably a carrier 400 capable of returning the micro mobility device 300. Information of the carrier 400 may further include carrier movement information that enables a carrier currently capable of moving to be identified in a management area. In addition, access location information as a part of the information of the carrier 400 may be set to a location closest to the micro mobility device within a permissible range of the management area. Accordingly, the movable carrier 400, which is preferably selected, may be a carrier capable of moving to the closest location and of being loaded with the micro mobility device 300.

Based on the charging support information and access location information of the movable carrier 400, which is preferably selected, residual power information of the micro mobility device 300 and mobility location information, the server 100 may finally determine whether or not the carrier 400 is located within a distance capable of return.

The subsequent process is actually the same as the embodiment of the micro mobility device 300 located in a specific region of interest.

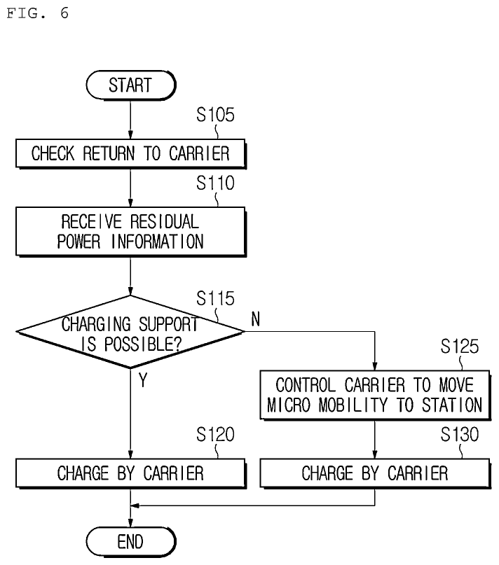

FIG. 6 is a flowchart showing a charging maintenance method through a movable carrier.

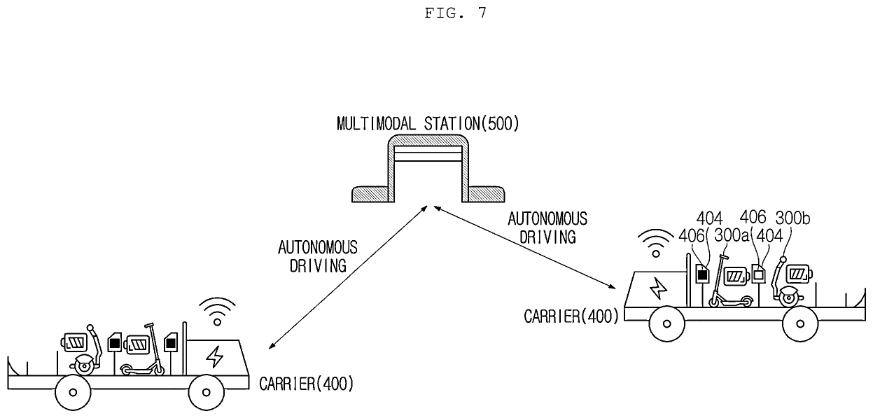

Like in FIG. 5, in case the micro mobility device 300 is returned to the movable carrier 400, the micro mobility device 300 may be loaded on a deck 402 of the carrier 400, as illustrated in FIG. 6 (S105). After being normally loaded, the movable carrier 400 may transmit a return message of the mobility device 300 to the server 100 and the user device 200. FIG. 7 is a view illustrating a movable carrier that charges a micro mobility device during autonomous driving.

The movable carrier 400 may receive residual power information at the time of returning the micro mobility device 300 (S110). Although the server 100 receives residual power information at the time of requesting use restriction in FIG. 5, since the micro mobility device 300 consumes power to move to the movable carrier 400 to which the micro mobility device 300 is to be returned, the mobility device 300 may transmit residual power at the time of normal return to the carrier 400.

Based on the residual power information of the mobility device 300 and maintenance support information of the movable carrier 400, the movable carrier 400 may determine whether or not charging support is available for the returned micro mobility device 300 (S115). Herein, the maintenance support information may be the charging support information described above.

In case the movable carrier 400 determines that charging support is possible (Y of S115), the carrier 400 may perform charging maintenance for a mobility device 300a that has been returned on the deck 402 (S120). Charging support may be performed, for example, when spare power included in charging support information is larger than the residual power of the micro mobility device 300a. In addition to the condition, charging support may be performed when residual power is larger than a second residual value. A second residual value may be set to be lower than a first residual value. For example, in case power required for the movable carrier 400 to charge the micro mobility device 300 so as to be at least rented (or allocated) is equal to or greater than a reference power value, a second residual value may be a value that is obtained by subtracting the reference power value from the residual power that enables the mobility device to be rented. The second residual value may be so designated as to prevent excessive troubles in charging support for another mobility device 300 through the movable carrier 400. Accordingly, in case residual power is below the second residual value, charging maintenance for a corresponding micro mobility device 300 may not be supported. Nevertheless, in case the number of micro mobility devices 300, which are returned to the movable carrier 400, is smaller than a preset number or current power of the carrier 400 is sufficient in consideration of an amount of charged power of a mobility deice 300, which is currently being charged, and an amount of power possessed by the carrier 400, the movable carrier 400 may charge a mobility device 300 with a second residual value. Sufficient power may mean that, even after charging a corresponding micro mobility device 300, the movable carrier 400 has an amount of energy (or power) not only to charge a previously mounted mobility device 300, as necessary, but also to move at least to the multimodal station 500.

As illustrated in FIG. 7, charging maintenance may be performed when the movable carrier 400 provides power to a charging kit 404 connected to the returned mobility device 300a. The charging kit 404, which is providing power, may be so operated as to enable a user to check the micro mobility device 300a, which is being charged, through a display 406. The mobility device 300a, which is being charged, may provide visually real-time residual power information according to power supply. In addition, the mobility device 300 may transmit the real-time residual power information to the movable carrier 400 and the server 100. In addition, even when the movable carrier 400 moves to another point at a request, the movable carrier 400 may be driven while keeping on charging a multiplicity of mobility devices 300a.

Meanwhile, in case the movable carrier 400 determines that charging support is impossible (N of S115), the carrier 400 may be controlled to carry the mobility device 300 to the multimodal station 500 without providing charging maintenance to a mobility device 300b which is returned on the deck 402 (S125). For example, spare power is lower than residual power of the micro mobility device 300b, charging maintenance may not be supported. As another example, in a case where residual power is lower than spare power but is equal to or lower than a second residual value, charging maintenance may not be supported. Even when residual power is equal to or lower than a second residual value, charging may be supported according to an example enabling charging support. The returned mobility device 300b may be connected to the charging kit 404, but the charging kit 404 may not provide power and may operate to let a user see the micro mobility device 300b is not being charged through the display 406.

The micro mobility device 300b, for which charging is not supported, may transmit a charging request message to the server 100 via the movable carrier 400. For example, when a movement condition is satisfied, the server 100 may control and move the movable carrier 400 loaded with the mobility device 300b to the multimodal station 500 within a management area, in response to the charging request message. As an example, the movement condition may be that the number of mobility devices 300b, which transmit a charging request, is equal to or greater than a preset number. As another example, the movement condition may be that the number of mobility device 300b, which transmit a charging request, exceeds the number of mobility devices 300a that are being charged. The movable carrier 400, which is loaded with the mobility device 300a currently being charged and the mobility device 300b requesting charging, may move to the multimodal station 500, while continuing to charge the mobility device 300a. In case the movable carrier 400 drives autonomously, the server 100 may provide the carrier 400 with travel route information to the multimodal station 500 in communication with the micro mobility device 300, as illustrated in FIG. 7. In case the movable carrier 400 is operated in manned manner, the server 100 may transmit a message requesting to move to the multimodal station 500 to a driver of the carrier 400.

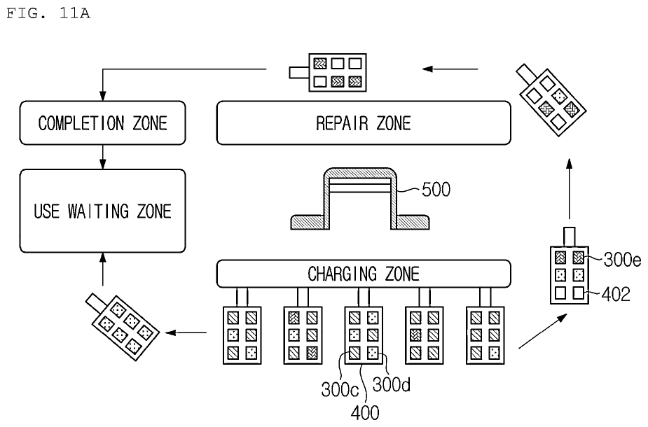

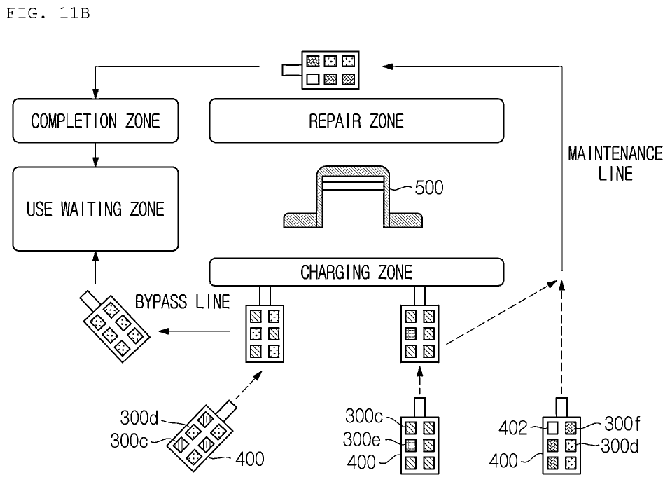

Next, when the movable carrier 400 arrives at the multimodal station 500, the movable carrier 400, still loaded with the micro mobility device 300 requesting charging, may move to a charger located in a charging zone of the station 500, and the charger may charge the mobility device 300. As an example, charging may be implemented by separating the micro mobility device 300b requesting charging from the movable carrier 400 and connecting the mobility device 300b to the charger. As another example, charging may be performed in a method that connects a connector for power supply, which is on the movable carrier 400 loaded with the micro mobility device 300b, with a port of a charger and provides power from the charger to the mobility device 300b via the carrier 400 (S130). Detailed examples are described with reference to FIG. 11A and FIG. 11B.

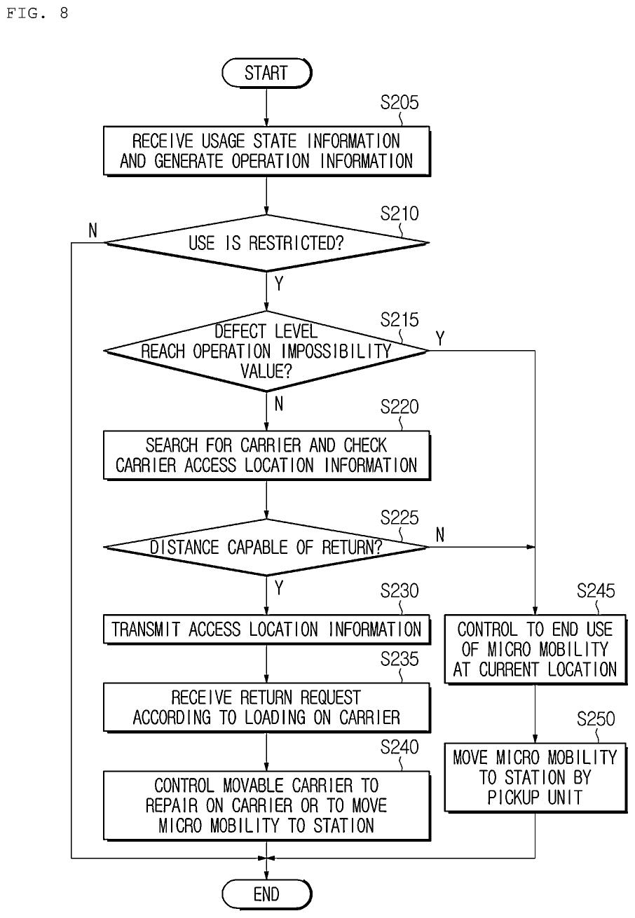

FIG. 8 is a flowchart showing a managing process of repair maintenance using a movable carrier.

Like in FIG. 5, the micro mobility device 300 in use may transmit usage state information to the user device 200. The user device 200 may generate operation information of the mobility device 300 based on the received usage state information (S205).

For example, usage state information may be data of a sensor mounted on the mobility device 300. Specifically, usage state information may be location information, speed information, residual power information, and vibration information, which are obtained from GPS, a speedometer, a power meter, and a vibration measuring sensor, which are mounted on the mobility device 300.

Operation information may be information that indicates an operation state and a degree of damage for the mobility device 300 caused by a user's operation of the mobility device. Specifically, the operation information may be information that infers an operating condition and a degree of damage for each component based on data obtained from sensors mounted on the mobility device 300.

As for generating operation information, first, the user device 200 may generate and produce operation record information based on sensor data. For example, operation record information of the mobility device 300 may be driving routes, distance, power usage, sudden acceleration, sudden deceleration, the number of sudden turns, degree of vibration, the number of sudden brakes, braking situations, and the like. Subsequently, the operation record information may be analyzed so that operation information may be generated according to an operational state and a degree of damage in a component.

For example, in the case of a brake system, operation record information including driving routes, sudden deceleration, the number of sudden turns, the number of sudden brakes, a degree of vibration, and braking situations may be generated based on sensor data. It is possible to produce, from the operation record information, a road surface condition in a driving route, a vibration level according to road surfaces, a slope driving distance, excessively sudden deceleration, the number of sudden brakes exceeding a certain deceleration range for a predetermined time, and the like. Through machine learning based on information thus produced, an operational state of a brake system and a degree of damage may be estimated, and corresponding operation information may be generated. For example, data related to vibrations caused by poor road surface condition, driving a long distance on a downward slope, frequent sudden braking, and the like may enable operational states like drastic brake pad wear, clearance between pad and lining, and brake slips to be inferred. Also, the data may be useful to estimate a degree of damage in a brake system by calculating a degree of pad wear, a clearance between pad and lining, and a degree of slip.

For example, in the case of a motor system, operation record information including driving routes, a distance, a degree of sudden acceleration, a degree of vibration, and power usage may be generated based on sensor data. It is possible to produce, from the operation record information, a road surface condition in a driving route, a vibration level, a driving distance, excessively sudden acceleration, power usage, and the like. Through machine learning based on information thus produced, an operational state of a motor system and a degree of damage may be estimated, and corresponding operation information may be generated. Vibrations caused by poor road surface condition, a long driving distance, sudden acceleration exceeding a certain range of speed, and power overuse may be useful to infer, in a motor system, operational states such as motor deterioration due to heat, abnormal wiring connections, poor motor rotation, abnormal delivery of power, and poor mating of each component. Also, this may contribute to estimating a degree of damage in a motor system.

For example, in the case of a suspension system, operation record information including driving routes, a distance, power usage, a degree of sudden acceleration, a degree of sudden deceleration, the number of sudden turns, a degree of vibration, and the number of sudden brakes may be generated based on sensor data. It is possible to produce, from the operation record information, a road surface condition in a driving route, a vibration level, a driving distance, excessively sudden acceleration/deceleration, sudden braking, and the like. Vibrations due to poor road surface condition, a long driving distance, and sudden acceleration/deceleration exceeding a certain speed range may be useful to infer an operational state like a shock absorbing degree of suspension in a suspension system. Also, this may contribute to estimating a degree of damage in a suspension system.

In addition, operation information may be generated not only from sensor data but also from texts, images, and videos that are related to abnormal operation and failure in a component of the mobility device 300 and are received the user device 200. The operation information may be an operational state and a degree of damage in each component, which are inferred from texts and images. When receiving a text about an abnormality of a component, the user device 200 may request an image and a video for accurate checking to the user device 200. When the user device 200 receives an image or a video, the user device 200 may generate operation information by estimating, through machine learning, whether or not a component has an abnormality or failure and then transmit the operation information to the server 100. As another example, the server 100 may receive an image or a video from the user device 200, generate and record operation information, and then transmit the operation information to the user device 200 and the micro mobility device 300.

Next, based on operation information, the user device 200 may determine whether or not the micro mobility device 300 in current use is subject to use restriction (S210).

For example, determination of use restriction may be determining whether or not an operation of the micro mobility device 300 has an abnormality, through machine learning for the operation state and damage in operation information. In the case of a brake system, at least one of an estimated degree of slip of brake, a degree of pad wear, and/or a degree of clearance is equal to or greater than a predetermined criterion, it may be determined that the mobility device 300 has an abnormality in braking. In the case of a motor system, when estimated heat of a motor, a motor output torque, non-uniformity of output torque, and a component expected to be poorly combined meet an abnormality criterion, it may be determined that a motor has an abnormality. In the case of a suspension system, a shock absorbing degree of suspension is equal to or below a predetermined criterion, it may be determined that a shock absorbing function is abnormal. In addition, when operation information, which the user device 200 analyzes based on an image or a video, is exterior damage of the mobility device 300, the exterior damage is analyzed regarding whether or not it is equal to or greater than a permissible degree. If the exterior damage is equal to or greater than the permissible degree, it may be determined that no abnormality exists in the exterior.

As a result of this determination, when it is determined that use of the micro mobility device 300 is to be restricted, the user device 200 may transmit a use restriction request like in FIG. 5. In addition, the user device 200 may further transmit, to the server 100, use information including usage state information and operation information.

Next, the server 100 may analyze, based on the usage state information and the operation information, whether or not a corresponding component has caused damage equal to or above a predetermined level of defect. The server 100 may determine, according to the analysis, whether or not the level of defect reaches an operation impossibility value (S215).

For example, the operation impossibility value may be operation information, which makes the normal use of the micro mobility device 300 impossible when the micro mobility device 300 is driven a predetermined distance after the restriction request. The operational information may be an operational state and a degree of damage in each component. In the case of a brake system, the server 100 may analyze whether or not at least one, among a degree of brake pad wear, a clearance between pad and lining, and a degree of slip which, are based on an operation state, and a degree of damage related to the brake system, reaches an operation impossibility value related to brake. In the case of a motor system, the server 100 may analyze whether or not heat of motor, non-uniformity of output torque and the like reach an operation impossibility value related to motor. In the case of a suspension system, the server 100 may analyze whether or not a shock absorbing degree of suspension reaches an operation impossibility value. In the case of a steering unit or an exterior like board, the server 100 may analyze whether or not a user cannot stand in the normal position on the board or whether or not the steering unit is bent or damaged so excessively that a user cannot operate the mobility device.

When an analysis result is that the operation impossibility value is not reached (N of S215), the server 100 may, like in FIG. 5, confirm identification information of the micro mobility device 300, for which use restriction is requested. The server 100 may record the identification information in mobility status information and select the carrier 400 suitable for a state of the micro mobility device 300 by searching for the movable carrier 400 that is returnable. In addition, the server 100 may check access location information of the selected carrier 400 (S220).

When an analysis result is that the operation impossibility value is reached (N of S215), the server 100 may transmit a use ending message to the micro mobility device 300 and the user device 200, thereby controlling to end the use of the mobility device 300 (S245). A user may finally end the use by requesting return of the micro mobility device 300 at a current location to the server 100.

Next, the server 100 may request the multimodal station 500, which belongs to a nearest management area of the mobility device 300, to move a pickup unit to the mobility device 300 so that the pickup unit may be controlled to carry the mobility device 300 to the multimodal station 500 (S250). The unit may approach the mobility device 300 to pick it up or to provide a charging service.

Back to step S220, for a specific description of the subsequent process, the server 100 may identify a management area, to which a location of the micro mobility device 300 belongs, based on current location information of the micro mobility device 300 that is extracted from usage state information.

From movable carriers 400 belonging to the identified management area, the server 100 may receive at least one of the mobility device loading information, access location information, and/or maintenance support information of the movable carriers 400. Access location information may be location in a management area, where the movable carrier 400 stops, or may be a destination point, when the movable carrier 400 moves within a management area. Along with the charging support information in FIG. 5, maintenance support information may be information associated with component maintenance of the micro mobility device 300 which may be provided by the movable carrier 400. As the information associated with component maintenance was illustrated through FIG. 4, no further detailed description is provided.

Next, based on the information of the movable carriers 400 listed above, the server 100 may select preferably a carrier 400 capable of returning the micro mobility device 300. Based on the maintenance support information and access location information of the movable carrier 400, which is preferably selected, residual power information of the micro mobility device 300 and mobility device location information, the server 100 may finally determine whether or not the carrier 400 is located within a distance capable of return (S225). As for the determination process, in a case where the micro mobility device 300 has an operational state incapable of reaching any one of the carriers 400 that are preferably selected, the server 100 may determine that it is impossible to provide a movable carrier 400 capable of return.

In a case where the movable carrier 400 cannot be provided (N of S225), the above-described steps S245 and S250 may be performed.

When the movable carrier 400 exists within a distance where the micro mobility device 300 can be returned (Y of S225), the server 100 may finally determine the carrier 400 as a return carrier. The server 100 may transmit access location information of the movable carrier 400, which is expected to return the micro mobility device 300, to the user device 200 (S230). Also, the server 100 may control and stop the movable carrier 400 in the transmitted access location until the micro mobility device 300 is returned. In case the movable carrier 400 is moving to a destination point as early as before a use restriction request, the server 100 may control and make the movable carrier 400 drive autonomously to the access location in unmanned manner or move in manned manner so that the mobility device 300 may be returned. In addition, the server 100 may transmit an expected return message to the micro mobility device 300 either directly or via the user device 200.

Next, the user may drive the micro mobility device 300 to a corresponding movable carrier 400 by identifying access location information and load the micro mobility device 300 on the carrier 400. The carrier 400 may receive a return request of the mobility device 300 according to normal loading (S235). In response to a state where the micro mobility device 300 is normally loaded, the movable carrier 400 may transmit a load message to the user device 200. Receiving the load message, the user device 200 may transmit a return confirmation message to the server 100. In response to the message, the server 100 may transmit a use ending message to the user device 200 and the micro mobility device 300.

Next, based on the operation information received from the micro mobility device 300 and the maintenance support information of the movable carrier 400, the movable carrier 400 may determine whether or not the returned micro mobility device 300 may be supported by maintenance (or repair) and also determine whether or not to move the movable carrier 400 for maintenance in the movable carrier 400 or maintenance in the multimodal station 500 (S240).

Specifically, in case the movable carrier 400 determines that repair support is possible, the carrier 400 may perform repair maintenance for a component, for which repair is requested, in the returned mobility device 300 on the deck 402.

For example, when the movable carrier 400 runs in a manned manner, component maintenance may be performed by repairing a corresponding component of the micro mobility device 300, for which maintenance is requested, by the hands of a driver of the carrier 400 or another maintenance worker. As another example, even when the movable carrier 400 drives autonomously in an unmanned manner, a maintenance worker may move to the carrier 400, which is requested from the server 100, through his device and support maintenance of the micro mobility device 300 for which maintenance is requested.

Meanwhile, in a case where the movable carrier 400 determines that maintenance support is impossible for the micro mobility device that requests repair, the carrier 400 may be controlled to carry the mobility device 300 to the multimodal station 500 without providing repair maintenance to the returned mobility device 300 on the deck 402.

The micro mobility device 300b, for which repair is not supported, may transmit a repair request message to the server 100 via the movable carrier 400. For example, when a movement condition is satisfied, the server 100 may control and move the movable carrier 400 loaded with the mobility device 300 to the multimodal station 500 within a management area, in response to the repair request message. As an example, the movement condition may be that the number of mobility devices 300, which transmit a charging or repair request, is equal to or greater than a preset number. As another example, the movement condition may be that the number of mobility devices 300, which transmit a charging or repair request, exceeds the number of mobility devices 300 that are being charged or are in a normal state. The movable carrier 400 may be loaded not only with a mobility device 300, for which a maintenance request is made, but also with another mobility device 300 and move to the multimodal station 500 either by autonomous driving or in manned manner.

When the movable carrier 400 arrives at the multimodal station 500, the movable carrier 400, still loaded with the micro mobility device 300, for which charging or repair is requested, may move to a charging or repair zone of the station 500. The maintenance requested by the mobility device 300 may be performed. Detailed examples are described with reference to FIG. 11A and FIG. 11B.

The above-described embodiment assumes that the micro mobility device 300, for which use restriction is requested, is located in a specific region of interest. As another example, in case of the micro mobility device 300 not located in any management area, the above-described embodiment may be applied similarly, and as the detailed description is presented with reference to FIG. 5, it is not provided below.

In addition, the embodiment according to FIG. 8 limits use restriction of the micro mobility device 300 to an abnormal operational state of a component. However, the use restriction may be requested based on both an operational state caused by operation information and a charging state caused by residual power information. In this case, the embodiments of FIG. 5, FIG. 6, and FIG. 8 may be combined so that determination/request of use restriction, a search for the movable carrier 400, determination of maintenance support for the movable carrier 400, and the like may be performed.

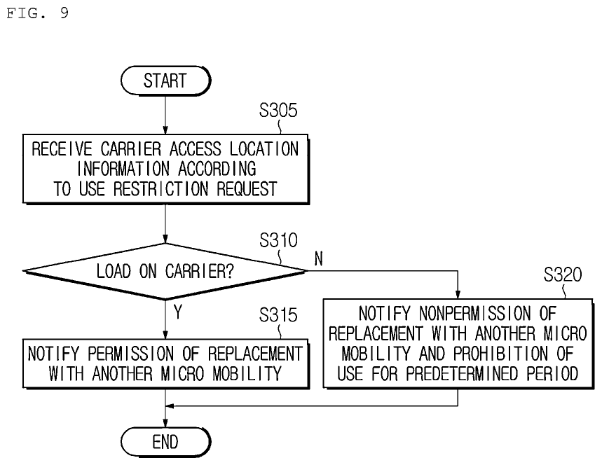

FIG. 9 is a flowchart showing a managing process when returning by a movable carrier.

Based on any one of the embodiments according to FIG. 5, FIG. 6, and FIG. 8, the user device 200 may request use restriction of the micro mobility device 300 to the server 100 and receive access location information of the movable carrier 400 from the server 100 (S305).

Next, a user may move the micro mobility device 300 to the movable carrier 400 by identifying the access location information. The carrier 400 may determine whether or not the user returns the mobility device 300 normally by loading the mobility device 300 on the deck 402 of the carrier 400 (S310).

Next, in case the micro mobility device 300 is returned to the movable carrier 400 (Y of S310), the carrier 400 may transmit a normal load message to the server 100 so that the server 100 may finally process the end of use of the mobility device 300. Next, at a rental request of the user device 200, the server 100 may transmit a replacement permission message for another mobility device loaded on the movable carrier 400 to the user device 200 (S315). The server may transmit, to the user device 200, list-type status information on an available mobility device 300 among micro mobility devices on the movable carrier 400.

In a case where the micro mobility device 300 is not returned to the movable carrier 400 even after receiving access location information (N of S310), the server 100 may transmit, to the user device, at least one of a replacement non-permission message for another micro mobility device 300 and/or a use prohibition message for a predetermined period (S320).

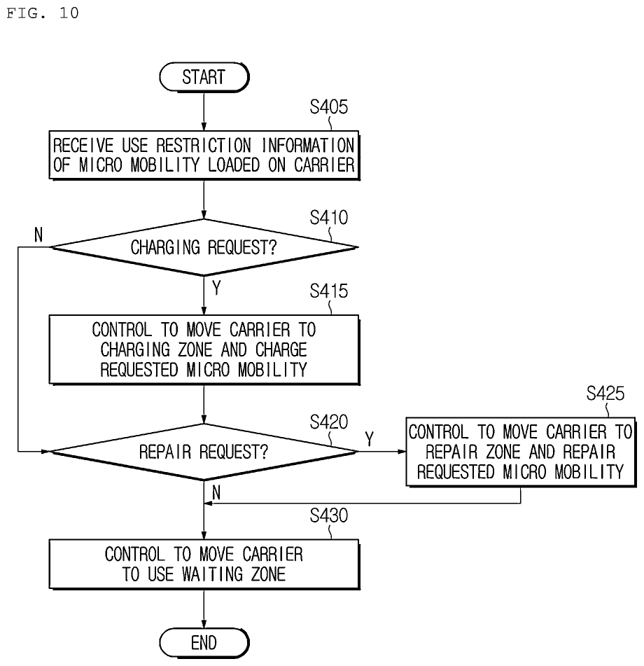

FIG. 10 is a flowchart showing a maintenance method at a multimodal station.

Hereinafter, the multimodal station 500 may be equipped with a separate server or a slave server, which is controlled by the server 100. The operation and communication described below may be performed by a server of the station 500. Hereinafter, for convenience of explanation, a server of the station 500 is referred to as the multimodal station 500.

According to the embodiments of FIG. 5, FIG. 6, and FIG. 8, the micro mobility device 300, for which use restriction is requested, is carried to the multimodal station 500 by being loaded on the movable carrier 400. The multimodal station 500 may receive use restriction information of the micro mobility device 300 from the server 100 and/or the movable carrier 400 (S405). The use restriction information may exclude use restriction information for a micro mobility device 300, for which the movable carrier 400 supports maintenance. The use restriction information may be use restriction information for a micro mobility device 300, of which the charging and/or repair request is not supported by the carrier 400, as in the above-described embodiment. The use restriction information may be a charging and repair request, for which the support from the multimodal station 500 is desired, along with usage state information and operation information at the time of use restriction. The repair request may be related to a repair or replacement of a component that is determined to have an abnormal state in the use restriction request.

FIG. 11A and FIG. 11B are views illustrating an example of maintenance at a multimodal station.

Like in FIG. 11A and FIG. 11B, the movable carrier 400 may be loaded with and carry a multiplicity of micro mobility devices 300. For example, the movable carrier 400 may be loaded with both micro mobility devices 300c and 300e, for which use restriction is requested, and a mobility device 300d for which use restriction is not requested. For example, a micro mobility device, for which use restriction is requested, may be at least one among the mobility device 300c requesting only charging, the mobility device 300e requesting both charging and repair, and the mobility device 300f requesting only repair.

The multimodal station 500 may analyze use restriction information of the micro mobility device 300 and thus may check whether or not there is a movable carrier 400 loaded with the mobility devices 300 requesting charging (S410).

In a case where there is a charging request (Y of S410), the multimodal station 500 may control and move the movable carrier 400 to a charging zone. The micro mobility device 300 requesting charging may be charged while being loaded on the carrier 400.

As illustrated in FIG. 11A and FIG. 11B, a charging zone may be equipped with a multiplicity of chargers, which may be connected to and charge the movable carrier 400. The multimodal station 500 may check whether or not charging support is performed for the movable carrier 400, whether or not charging is supported, or a status of chargers close to charge completion. Thus, the multimodal station 500 may designate a charger, which is to support charging for a carrier 400 that has newly arrived, and control and move the carrier 400 to the designated charger. For example, a charger may have a port that is connected to a connector for power supply in the carrier 400. Through interconnection with the carrier 400, a charger may provide charging only to the micro mobility devices 300c and 300e, which request charging. As an example, power may be provided as the movable carrier 400 activates only the charging kits 404 connected with the mobility devices 300c and 300e, which make a charging request. As another example, when the micro mobility device 300d has an available amount of power, even if no charging request is made, the movable carrier 400 may identify that mobility device 300d is not fully charged and provide power by activating the charging kit 404 connected with the mobility device 300d. In addition to this, the movable carrier 400 may be charged as necessary. A charger may end charging support after checking whether or not the micro mobility device 300 receiving the charging support is fully charged.

The multimodal station 500 may check whether or not the movable carrier 400, in which charging support is completed, is loaded with a micro mobility device 300e requesting repair (S420).

In a case where there is a repair request (Y of S420), the multimodal station 500 may control and move the movable carrier 400 to a repair zone along a maintenance line, as illustrated in FIG. 11A and FIG. 11B. The multimodal station 500 may enable suitable maintenance to be performed for the micro mobility device 300e requesting repair by providing use restriction information of the mobility device 300e to a device in the repair zone (S425). As described above, the use restriction information may include usage state information, operation information, and information on a component for which repair is requested.

Maintenance may be performed depending on a type of component, for which use is restricted. In the case of a brake system, for example, the maintenance may be replacement of pad, adjustment of clearance between pad and lining, and the like. In the case of a motor system, the maintenance may be wiring connection repair of a motor circuit, strengthening or tightening of a poorly-attached component, and the like. In the case of a suspension system or an exterior, the maintenance may be replacement of the suspension, a battery exchange, a board exchange, replacement or repair of a steering unit, and the like.

Maintenance of the mobility device 300e may be performed while the mobility device 300e is loaded on the movable carrier 400 or by separating the mobility device 300e, for which repair is requested, from the carrier 400. Maintenance information on the micro mobility device 300, which is completely repaired, may be transmitted from the multimodal station 500 to the server 100. The server 100 may update maintenance information of the corresponding mobility device 300e.

When only a normal mobility device is loaded on the movable carrier 400 by completely repairing or separating the micro mobility device 300e, which requests repair, the multimodal station 500 may control and move the carrier 400 to a use waiting zone, as illustrated in FIG. 11A and FIG. 11B (S430).

In order to move the movable carrier 400 loaded with a normal micro mobility device to a predetermined point of a management area, the use waiting zone may be a zone in which the movable carrier 400 waits for a movement request from the server. In addition, the use waiting zone may be utilized as a rental space of the micro mobility device 300. The user device 200 may request to use the mobility device 300 loaded on the movable carrier 400 in the zone. As another example, the multimodal station 500 may control the movable carrier 400 to make it stand by in a completion zone before the carrier 400 is moved to the use waiting zone, as in FIG. 11A and FIG. 11B. For example, in case the number of movable carriers 400 stopped at the use waiting zone is equal to or greater than a predetermined number, the multimodal station 500 may order the carrier 400 to stand by in the completion zone in order to avoid congestion in the use waiting zone.

Meanwhile, in the step S410, even when there is no charging request, if there is a repair request from at least one micro mobility device 300f among mobility devices loaded on the movable carrier 400, as illustrated in FIG. 11B, the multimodal station 500 may control and move the carrier 400 to a repair zone along a maintenance line without stopping by a charging zone. Then, the micro mobility device 300f, which requests only repair, may receive adequate maintenance in the repair zone, like in the step S425.

Like in the case of N of S420, the movable carrier 400, which provides charging support to only the micro mobility device that requests only charging, may be moved to a use waiting zone along a bypass line under the control of the multimodal station 500, as illustrated in FIG. 11B.

Meanwhile, in the steps S410 and S420, the movable carrier 400 loaded only with the micro mobility device 300 making neither a charging nor a repair request may be moved to a use waiting zone along a bypass line immediately after arriving at the multimodal station 500. As another example, when the movable carrier 400 checks residual power of a micro mobility device 300 loaded on it and determines that there is a mobility device 300 not fully charged, the movable carrier 400 may additionally request charging maintenance to the multimodal station 500. Thus, the multimodal station 500 may control and lead the carrier 400 to a charging zone and then move the carrier 400 to a use waiting zone after the micro mobility device 300 is fully charged.

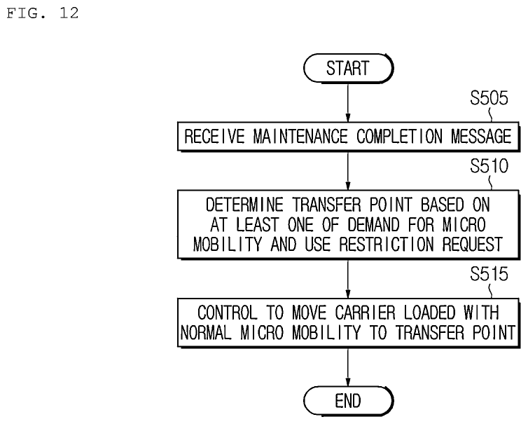

FIG. 12 is a flowchart showing a process of controlling a movable carrier after maintenance is completed.

Like in FIG. 10, FIG. 11A, and FIG. 11B, when maintenance related to charging or repair, which is requested by the micro mobility device 300, is completed and the movable carrier 400 stands by in a use waiting zone, the multimodal station 500 may receive a maintenance completion message of the carrier 400 (S505).

Next, the multimodal station 500 may determine a transfer point of the movable carrier 400 based on at least one of a degree of demand for the micro mobility device 300 and/or a request from the micro mobility device 300 of which the use is restricted (S510).

For example, a degree of demand may be a point where there are statistically many rental requests of the user device 200 in a management area of the multimodal station, a point where there is a relatively larger floating population, and a point which is a predetermined distance from points with many rental requests or floating population. A use restriction request is actually the same as mentioned in the embodiments of FIG. 5 and FIG. 8.

Subsequently, the multimodal station 500 may control and move the movable carrier 400, which stops at a use waiting zone and is loaded with a normal micro mobility device, to a transfer point. Such a move may be performed in manned manner or be implemented by unmanned autonomous driving, as in FIG. 7.

The above embodiment has described that the multimodal station 500 executes the process of FIG. 12 but is not limited thereto and the process may be performed by the server 100.

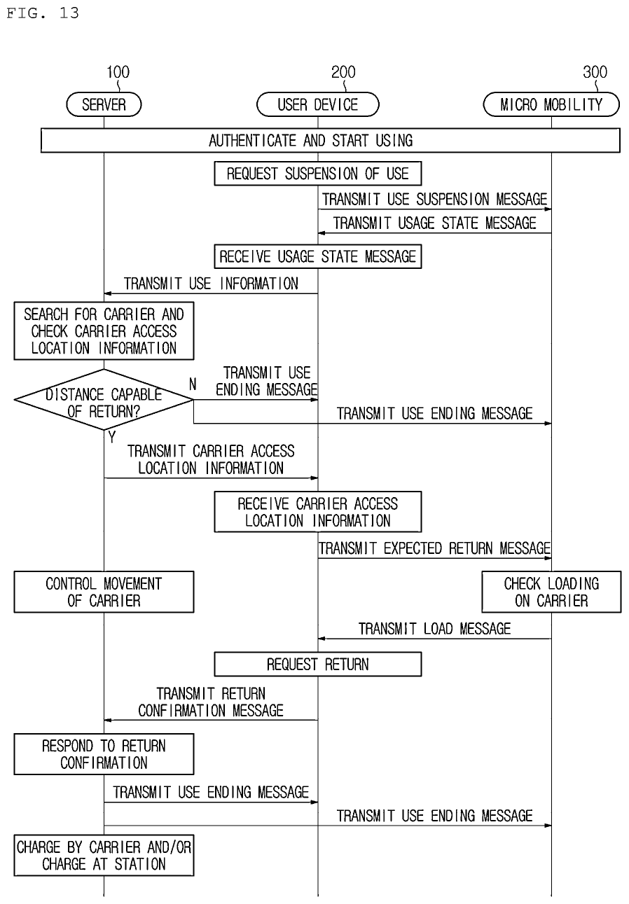

FIG. 13 is a flowchart showing a method for managing a micro mobility device through a management system according to another embodiment of the present disclosure.

The embodiment of the present disclosure describes return to a movable carrier and maintenance when the user device 200 voluntarily requests return of the micro mobility device 300 without a use restriction request. Apart from the processes related to a use restriction request in FIG. 5, FIG. 6, and FIG. 8, this embodiment is similar to the embodiments of the drawings. In this embodiment, what is similar to the embodiments of FIG. 5, FIG. 6, and FIG. 8 is only briefly described or has been omitted.

At a user's rental request, the user device 200 may provide a location of the available micro mobility device 300, request the micro mobility device 300 parked at a designated rental place or at an arbitrary place, and start using the micro mobility device 300.

Since the start of use, the user device 200 may transmit a use suspension message for the micro mobility device 300 to the server 100. In addition, the use suspension message may be transmitted to the micro mobility device 300. The mobility device 300 may transmit use information at time of suspension including usage state information to the server 100 via the user device 200. Use information may include usage state information and operation information. Usage state information may include the location information, residual power information, speed information, and vibration information of the micro mobility device 300. Such usage state information may be constantly transmitted to the user device 200 even during operation. In the present disclosure, for convenience of explanation, it is described that usage state information is transmitted to and recorded in the user device 200 and the user device 200 analyzes charging and operational states of the mobility device based on the usage state information. However, as another example, usage state information may be cumulatively recorded in an identification device of the mobility device 300 or in an authentication and identification device applied to the mobility device 300. The state of the mobility device 300 may be analyzed as the identification device transmits sensor data to the server 100. As yet another example, usage state information may be transmitted to the server 100, not the user device 200 and an identification device, and the server 100 may analyze charging and operational states of the mobility device 300 based on the usage state information. In this case, the server 100 may transmit a message for restricting use of the micro mobility device 300 to the micro mobility device 300 and the user device 200 according to an analysis result.

The server 100 may confirm identification information of the micro mobility device 300, for which use suspension is requested, record the identification information in mobility status information, and select the carrier 400 suitable for a state of the micro mobility device 300 by searching for the movable carrier 400 that is returnable. The server 100 may check access location information of the selected carrier 400.

For a description of the process, the server 100 may identify a management area, to which a location of the micro mobility device 300 belongs, based on current location information of the micro mobility device 300 that is extracted from usage state information.

From movable carriers 400 belonging to the identified management area, the server 100 may receive at least one of the mobility device loading information, access location information, and/or maintenance support information of the movable carriers 400. In this embodiment, for convenience of explanation, it may be assumed that maintenance support information includes charging support information according to power of the movable carrier 400.

Based on the information of the movable carriers 400 listed above, the server 100 may select a carrier 400 capable of returning the micro mobility device 300. Based on the charging support information and access location information of the movable carrier 400, which is selected, residual power information of the micro mobility device 300 and mobility device location information, the server 100 may finally determine whether or not the carrier 400 is located within a distance capable of return (e.g., a distance in which the mobility device is capable of traveling to return). Detailed description about the determination process is similar to the one in FIG. 5 and thus is not provided.

In a case where the movable carrier 400 cannot be provided, the server 100 may transmit a use ending message to the micro mobility device 300 and the user device 200. In addition, besides transmitting the message, the server 100 may perform final return processing by controlling and deactivating the micro mobility device 300. In this case, the server 100 may request the multimodal station 500, which belongs to a nearest management area of the mobility device 300, to move a pickup unit or a supporting unit dedicated to charging to the mobility device 300. The unit may approach the mobility device 300 to pick it up or to provide a charging service.

When the movable carrier 400 exists within a distance where the micro mobility device 300 can be returned, the server 100 may finally determine the carrier 400 as a return carrier. The server 100 may transmit access location information of the movable carrier 400, which is expected to return the micro mobility device 300, to the user device 200. Also, the server 100 may control and stop the movable carrier 400 in the transmitted access location until the micro mobility device 300 is returned. In addition, the server 100 may transmit an expected return message to the micro mobility device 300 either directly or via the user device 200.

A user may drive the micro mobility device 300 to a corresponding movable carrier 400 by identifying access location information and put the micro mobility device 300 on the carrier 400. In response to a state where the micro mobility device 300 is normally loaded, the movable carrier 400 may transmit a load message to the user device 200. Receiving the load message, the user device 200 may transmit a return confirmation message to the server 100. In response to the message, the server 100 may transmit a use ending message to the user device 200 and the micro mobility device 300.

The movable carrier 400 may determine whether or not to support charging maintenance for the micro mobility device 300 loaded on the carrier 400 based on current charging support information of the carrier 400. According to an amount of spare power, the movable carrier 400 may charge the mobility device 300 through the charging kit 404 or transmit residual power information to the server 100 without charging support so as to be controlled to charge the mobility device 300 through a charging zone when arriving at the multimodal station 500.

The above-described embodiment assumes that the micro mobility device 300, for which use restriction is requested, is located in a specific region of interest. As another example, in case of the micro mobility device 300 not located in any management area, the above-described embodiment may be applied similarly.

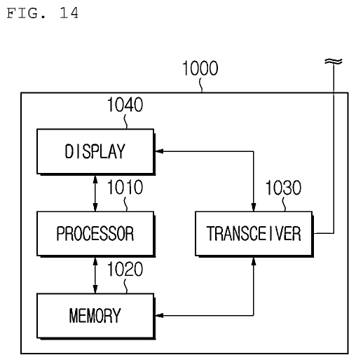

FIG. 14 is a view illustrating a device configuration according to an embodiment of the present disclosure. Referring to FIG. 14, a device may include at least one or more among the above-described micro mobility device, a device, a server, and a RSU. In other words, the device may communicate and work with another device, which is not limited to the above-described embodiments. As an example, for the above-described operation, a device 1000 may include one or more among a processor 1010, a memory 1020, a transceiver 1030, and a display 1040. In other words, the device may include a configuration necessary to communicate with another device or may display a data processing result between each other. In addition, as an example, the device may include other configurations than the above-described configuration. In other words, the device may have a configuration, which includes the above-described device for communicating with another device but is not limited thereto, and may be an device operating based on what is described above.

While the methods of the present disclosure described above are represented as a series of operations for clarity of description, it is not intended to limit the order in which the steps are performed. The steps may be performed simultaneously or in a different order as necessary. In order to implement the method according to the present disclosure, the described steps may further include other steps, may include some of the described steps but not all of the steps, or may include other additional steps instead of or in addition to some of the steps described.

The various embodiments of the present disclosure are not a list of all possible combinations and are intended to describe representative aspects of the present disclosure. The matters described in the various embodiments may be applied independently or in combination of two or more.

In addition, various embodiments of the present disclosure may be implemented in hardware, firmware, software, or a combination thereof. In the case of implementing the present inventive concept by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on a device or a computer, a non-transitory computer-readable medium having such software or commands stored thereon, and executable on the device or the computer.

What is claimed is:

1. A method for managing a micro mobility device through a computing device, the method comprising:
obtaining access location information of a movable carrier for returning the micro mobility device and checking whether or not it is possible to return the micro mobility device to the movable carrier, based on use information of the micro mobility device and the access location information; and
performing maintenance on the micro mobility device that is returned, when it is possible to return the micro mobility device to the movable carrier and it is confirmed, based on the use information and maintenance support information of the movable carrier, that maintenance of the micro mobility device is capable of being performed by the movable carrier.

2. The method of claim 1, wherein the movable carrier has an autonomous driving function.

3. The method of claim 2, wherein the movable carrier is capable of autonomously driving within a management area that is set to a predetermined range from a multimodal station which is installed in a fixed location.

4. The method of claim 3, wherein, when the micro mobility device is located outside a management area, the access location information is set to a location closest to the micro mobility device within a permissible range in the management area, and the movable carrier is capable of moving to the closest location.

5. The method of claim 1, wherein the use information has residual power information of the micro mobility device and mobility device location information, and
wherein the checking of whether or not return to the movable carrier is possible comprises determining whether or not the return is possible based on the power residual information, the mobility device location information, or the access location information.

6. The method of claim 1, wherein the maintenance support information comprises charging support information according to power of the movable carrier, and
wherein the method further comprises controlling not to perform charging maintenance for the micro mobility device that is returned to the movable carrier, when it is confirmed that maintenance for charging the micro mobility device is impossible to perform.

7. The method of claim 1, wherein the movable carrier is selected by being searched for based on at least one among location information of the micro mobility device, mobility device loading information of the movable carrier, and/or the maintenance support information.

8. The method of claim 1, wherein the use information is recorded in at least one among: a user identification device, which is mounted on a user device and is capable of exchanging data with the micro mobility device; a mobility identification device mounted on the micro mobility device; and an authentication identification device applicable to the micro mobility device for user authentication, and
wherein the recorded use information is transmitted to at least one of the user device and a server.

9. The method of claim 1, further comprising:
transmitting, to a user device, a permission message for replacement with another mobility device loaded on the movable carrier, when the micro mobility device is returned to the movable carrier; and
transmitting, to the user device, at least one of a non-permission message for replacement with another micro mobility device and a use prohibition message for a predetermined period, when the micro mobility device is not returned to the carrier.

10. The method of claim 1, further comprising:
moving the movable carrier loaded with the micro mobility device to a multimodal station that is installed in a fixed location;
determining whether or not there is a micro mobility device for which a charging request is made;
moving the movable carrier to a charging zone of the multimodal station, when the charging request is made, and charging the micro mobility device for which the charging request is made;
moving the movable carrier to a use waiting zone of the multimodal station after charging the micro mobility device; and
moving the movable carrier to the use waiting zone of the multimodal station when the charging request is not made.

11. The method of claim 10, further comprising:
determining a transfer point of the movable carrier that is located in the use waiting zone, based on a degree of demand for the micro mobility device; and
controlling to move the movable carrier loaded with the micro mobility device to the transfer point.

12. The method of claim 1, further comprising:
determining whether or not use of the micro mobility device is restricted, based on the use information related to a usage state and operation of the micro mobility device, before the checking of whether or not it is possible to return the micro mobility device to the movable carrier,
wherein the checking of whether or not it is possible to return the micro mobility device to the movable carrier is performed when the use is restricted.

13. The method of claim 12, wherein the use information has residual power information of the micro mobility device and mobility device location information,
wherein the determining of whether or not the use is restricted comprises determining use restriction of the micro mobility device, when residual power is equal to or less than a first residual value, and
wherein the checking of whether or not return to the movable carrier is possible comprises determining whether or not the return is possible based on the power residual information, the mobility device location information, and the access location information.

14. The method of claim 12, wherein the use information comprises usage state information, which has residual power information of the micro mobility device and mobility device location information, and operation information based on an operational state of the micro mobility device,
wherein the determining of whether or not the use is restricted comprises determining whether or not a preset defect level is reached based on the operation information, and
wherein the checking of whether or not the return to the movable carrier is possible comprises determining whether or not the return is possible, based on the usage state information, the operation information, and the access location information.

15. The method of claim 12, further comprising:
moving the movable carrier loaded with the micro mobility device to a multimodal station that is installed in a fixed location;
determining whether or not there is a micro mobility device making a charging request, based on use restriction information of the micro mobility device of which use is restricted;
moving the movable carrier to a charging zone of the multimodal station, when the charging request is made, and charging the micro mobility device making the charging request;
determining whether or not there is a micro mobility device making a repair request, based on the use restriction information; and
moving the movable carrier to a repair zone of the multimodal station, when the repair request is made, and requesting to repair the micro mobility device making the repair request.

16. The method of claim 15, further comprising:
moving the movable carrier to a use waiting zone of the multimodal station, in a case where the micro mobility device loaded on the movable carrier does not make the repair request, after the charging of the micro mobility device.

17. The method of claim 15, further comprising:
moving the movable carrier to a repair zone of the multimodal station, when the charging request is not made but the repair request is made; and
moving the movable carrier to a use waiting zone of the multimodal station, when neither the charging request nor the repair request is made.

18. The method of claim 15, further comprising:
determining a transfer point of the movable carrier based on at least one of a degree of demand of the micro mobility device or a request from a micro mobility device, of which use is restricted, when maintenance of the micro mobility device is completed in the multimodal station; and
controlling to move the movable carrier loaded with a normal micro mobility device to the transfer point.

19. A computing device for managing a micro mobility device, the computing device comprising:
a transceiver configured to transmit and receive a signal; and
a processor configured to control the transceiver,
wherein the processor is further configured to
obtain access location information of a movable carrier for returning the micro mobility device,
check whether or not it is possible to return the micro mobility device to the movable carrier, based on use information of the micro mobility device and the access location information, and
control to perform maintenance for the micro mobility device that is returned, when it is possible to return the micro mobility device to the movable carrier and it is confirmed, based on the use information and maintenance support information of the movable carrier, that maintenance of the micro mobility device is capable of being performed by the movable carrier.

20. A server implemented by a computing device and capable of executing a management process of a micro mobility device, the server comprising:
a transceiver configured to transmit and receive a signal; and
a processor configured to control the transceiver,
wherein the processor is further configured to
search for a movable carrier for returning the micro mobility device and obtain access location information of the movable carrier,
check whether or not it is possible to return the micro mobility device to the movable carrier, based on use information associated with a state of the micro mobility device and the access location information, and
control to perform maintenance for the micro mobility device that is returned, when it is possible to return the micro mobility device to the movable carrier and it is confirmed, based on the use information and maintenance support information of the movable carrier, that maintenance of the micro mobility device is capable of being performed by the movable carrier.
